(19) United States
(12) Patent Application Publication
(10) Pub. No.: US 2005/0213742 A1
(43) Pub. Date: Sep. 29, 2005

(54) Call center system and call reservation method

(75) Inventor: Yasuhide Fukuzawa, Fukuoka (JP)

Correspondence Address: STEVENS DAVIS MILLER & MOSHER, LLP, 1615 L STREET, NW, SUITE 850, WASHINGTON, DC, 20036, US

(73) Assignee: MATSUSHITA ELECTRIC INDUSTRIAL CO., LTD., Osaka (JP)

(21) Appl. No.: 11/074,018

(22) Filed: Mar. 8, 2005

(30) Foreign Application Priority Data
Mar. 10, 2004 (JP) P. 2004-066906
Apr. 27, 2004 (JP) P. 2004-130993

(51) Int. Cl. H04M 3/00; H04M 5/00

(52) U.S. Cl. 379/265.02

(57) ABSTRACT

It is characterized by a call center server equipped with selection means 55 connected to an exchange which forms a talk channel between an external line and a plurality of extension telephones and selects a call reception destination of the selected call from the external line, and sets up it as a call reservation destination, call reservation means 56 which associates the selected call from the external line with an extension telephone as the call reservation destination, and stores them as talk reserved call information, in storage means, and extension line control means 52 which transmits, on the occasion that an extension telephone of talk reserved call information became available to receive a call, such notification that a distribution waited call, which can not be received by this extension telephone, is allowed to be received, to the exchange.

### BACKGROUND OF THE INVENTION

This invention relates to a call center system of carrying out incoming call distribution from an external line to a plurality of operators, a server, an operator terminal and a computer program which is used in the call center system, and relates to a call reservation method of a call center system.

In a call center, operators who have technical knowledge for receiving orders, inquiries, complaints etc. of commercial products from customers, and operators who are in charge of complaint handling, are dealing with telephone calls.

In an exchange which is used in a conventional call center, in order to effectively distribute calls which were arrived, to respective operators, there is an exchanger in which an automatic call distribution processor (hereinafter, referred to as ACDP) was implemented. This ACDP is used for effectively processing calls by sorting out extension telephones for receptions into call reception groups, managing calls which were arrived by an call reception group, distributing them to extension telephones in a vacant call reception group, and connecting them.

As a conventional call center system in which the suchlike ACDP was implemented, what was described in (Patent Document 1) has been known. The call center system, which was described in (Patent Document 1), is made available for high traffic, by connecting a plurality of exchanges in each of which ACDP was implemented through the use of a dedicated communication line, and carrying out distribution control of calls from a general public network to a most suitable extension telephone in call reception groups which are connected to respective exchanges.

Alternatively, depending on circumstances with customers, there is such a case that handling of a customer is carried out and then, a telephone is hanged up, and thereafter, it is understood to have a telephone call from the customer again. For example, in case of a call center as a window which accepts technical inquiries, it is such a case that an operator requests for checking of operations, to a customer who made a telephone call because of breakdown of a commercial product, and the operator is waiting for a report of its result.

However, when incoming calls are distributed by the above-described ACDP, it is not possible to tell which operator receives a call of the customer who made an inquiry. When the call of the customer reached to an operator who is different from a previous operator, the customer has need to tell progress so far in each case. It is conceivable that database regarding inquiry content is shared with operators, and the call is transferred to an operator who got a telephone call previous time, with reference to the database, but it is troublesome to transfer in each case.

Consequently, a communication apparatus, which can easily transfer without requiring manpower and without taking time, has been proposed and described in (Patent Document 2).

The communication apparatus, which was described in (Patent Document 2), is of such a configuration that, when there is an incoming call in ISDN (Integrated Services Digital Network), caller number notification information of a calling party, and an extension number with high frequency of calls to the calling party are stored in a storage section, and when there was an incoming call from the caller number again, it is transferred to an extension number which was finally turned in a call status.

[Patent Document 1] JP-A-2001-144860 publication

[Patent Document 2] JP-A-5-327902 publication

A call center system, which is described in (Patent Document 1), queues a call from a general public network to a call receiving order queue, and it is queued to a call receiving order queue of an extension telephone which appears to be most suitable in an optimum call reception group by scanning the call receiving order queue, and therefore, incoming calls are distributed in the order corresponding to accepted calls.

Therefore, they are automatically distributed in the order corresponding to extension telephones which become available to receive calls, and in the order corresponding to acceptance of incoming calls. It is because ACDP automatically determines a distribution destination and allocates. On that account, it is impossible to realize a call with an arbitrary call which is queued in the call receiving order queue even if it is desired to make a call after an operator completed the call.

In addition, in the communication apparatus which is described in (Patent Document 2), on the basis of caller number information of a calling party, it is automatically transferred to an extension number with high frequency of calls with the calling party. Therefore, there occurs such a case that it is automatically transferred to an extension number of another operator, and an operator, who made a call, can not necessarily make a call with the same calling party next time, without fault.

### SUMMARY OF THE INVENTION

The invention aims to provide a system of a call center server with high convenience, in which an operator can easily select a call from an external line, which was turned into a distribution waiting (reception waiting) status since there is no extension telephone which is available to receive a call and queuing is carried out, and it is possible to select an extension telephone by which an incoming call is allowed to be received.

In addition, it aims to provide a call center system with high convenience, which can easily make a call reservation by which an incoming call is allowed to reach to an appropriate operator, in case that there was a call again from the same customer.

A call center server of the invention is characterized, in a call center server connected to an exchange which forms a talk channel between an external line and a plurality of extension telephones and allows a call from the external line to be received by the extension telephone, the server includes selection means which selects a call from one or more external lines, which is in a reception waiting status to extension telephones, and selects a call reception destination of the selected call from the external line, and sets up it as a call reservation destination, call reservation means which associates the selected call from the external line with an extension telephone as the call reservation destination, and stores them as talk reserved call information, in storage means, and call reception notification means which transmits, on the occasion that the extension telephone, which was associated with the talk reserved call information, became available to be received, such notification that the selected call from the external line is allowed to be received by this extension telephone, to the exchange.

A call center server of the invention is characterized, in a call center server connected to operator terminals which are installed as pairs with each of a plurality of extension telephones, and an exchange which forms a talk channel between an external line and the plurality of extension telephones and allows a call from the external line to be received by the extension telephone, by being equipped with call reservation control means which stores, as a call reservation destination, talk reserved call information associated with an extension telephone selected to a call from the external line, by an operator terminal which becomes a pair with an extension telephone by which a call from the external line was received, in storage means, and call reception request means which notifies to an exchange so as to allow an extension telephone which was associated as the call reservation destination to receive a call, when a call from the external line, which was associated with the talk reserved call information, is incoming to the exchange.

As above, the invention is equipped with selection means which selects a call from one or more external lines, which is in a reception waiting status to extension telephones, and selects a call reception destination of the selected call from the external line, and sets up it as a call reservation destination, call reservation means which makes a connection of the selected call from the external line with an extension telephone as the call reservation destination, and stores them as talk reserved call information, in storage means, and connection notification means which transmits, on the occasion that the extension telephone, which was associated with the talk reserved call information, became available to be received, such notification that the selected call from the external line is allowed to be received by this extension telephone, to the exchange, and thereby, an operator can easily select a call from an external line with which the operator wishes to talk, among calls from the external line which were turned into a reception waiting status since there is no extension telephone which is available to receive a call, and can select an extension telephone by which a call is received. Thus, it is possible to realize a system of a call center server with high convenience and efficiency.

By the call reservation means, a call from the external line, which can not be received, is associated with an extension telephone as a call reservation destination, and stored in the storage means, as talk reserved call information, and by the connection notification means, on the occasion that the extension telephone, which was associated in the talk reserved call information, become available to receive a call, such notification that the reception waiting call from the external line is allowed to be received by this extension telephone is transmitted to an exchange, and thereby, it is possible to select a call from one or more external lines, which was turned into a reception waiting status since there is no extension telephone which is available to receive a call, and to select an extension telephone by which a call is allowed to be received. Thus, it is possible to allocate a call from the external line which can not receive a call and was turned into a reception waiting status, to an operator who uses an extension telephone most suitable for response, and therefore, it is possible to realize a call center system with high convenience and efficiency.

In addition, by the notification reservation reception means, a call reservation destination, which was selected by an operator terminal, is notified to call reservation means, and thereby, it is possible to select an extension telephone by which a call from an external line, which was turned into a reception waiting status since there is no extension telephone which is available to receive a call, is allowed to be received.

The call reservation control means notifies a warning to an operator terminal in case that it is not possible to receive the talk reserved call information even when predetermined time has passed over, and therefore, it is possible to suppress a long chat of an operator who was reserved for call.

The call reservation control means releases a call reservation and allows another extension telephone which is available for reception, to receive a call from an external line, in case that it is not possible for an extension telephone to receive a call even when predetermined time has passed over after a warning was notified, and therefore, it is possible to shorten waiting time to a customer who is forced to wait while the customer can not make a call.

By reception means, information of a call from one or more external lines, which is in a reception waiting status to extension telephones, is received by a call center server, and by selection means, one or more calls from the external line, which are in a reception waiting status to extension telephones, are selected, and call reception destinations of the selected calls from the external line are selected from a plurality of extension telephones and set up as call reservation destinations, and by call reservation notification means, information of the selected call from the external line is associated with an extension telephone as a call reservation destination, and is notified to a call center server as talk reserved call information, and therefore, it is possible to select an extension telephone which is allowed to receive a call from the external line, which was turned into a reception waiting status since there is no extension telephone which is available to receive a call, from an operator terminal side.

The invention is equipped with call reservation control means which stores, as a call reservation destination, talk reserved call information associated with an extension telephone selected to a call from the external line, by an operator terminal which becomes a pair with an extension telephone by which a call from the external line was received, in storage means, and call reception request means which notifies to an exchange so as to allow an extension telephone which was associated as the call reservation destination to receive a call, when a call from the external line, which was associated with the talk reserved call information, is incoming to the exchange, and thereby, it is possible to have an extension telephone, which was set up as a call reservation destination, received a call from the external line, which was associated with talk reserved call information, when it was received by an exchange again, and therefore, in case that the same customer made a call again, it is possible to easily allow an extension telephone which the same operator is using, to receive the call, and it is possible to realize a call center system with high convenience.

By the call reservation control means, it is possible to store talk reserved call information which was set up as a call reservation by an operator terminal, in storage means. In addition, by call reception request means, when a call from the external line, which was associated with the talk reserved call information, was made again, it is possible to allow an extension telephone, which an operator, who was reserved for call, uses and which was set up as a call reservation destination, to receive this call from the external line.

It is characterized by having a function which removes talk reserved call information from the storage means, and by the call reservation control means, it is possible to set up an expiration date to a call reservation.

By distribution waited call management means, in case that the talk reserved call from the external line was received, it is possible to allow an extension telephone which becomes a pair with an operator terminal which was reserved for call, in preference to other distribution waited calls.

By notification means, it is notified to an operator terminal which was reserved for call that the talk reserved call from the external line was received, and thereby, it is possible to inform an operator of reception of the talk reserved call from the external line.

By notification means, it is possible to notify talk reserved call information which was set up as a call reservation by call reservation means, to a call center server.

By reception means, such notification that the talk reserved call from the external line was received, is received, and by display means, it is displayed, and thereby, it is possible to inform an operator of reception of the talk reserved call from the external line.

By call reservation control means, it is possible to store talk reserved call information which was set up as a call reservation by an operator terminal, in storage means. In addition, by call reception request means, when a call from the external line, which was associated with talk reserved call information, was made again, it is possible to allow an extension telephone which was set up as a call reservation destination, to receive this call from the external line.

### DETAILED DESCRIPTION OF THE DRAWINGS

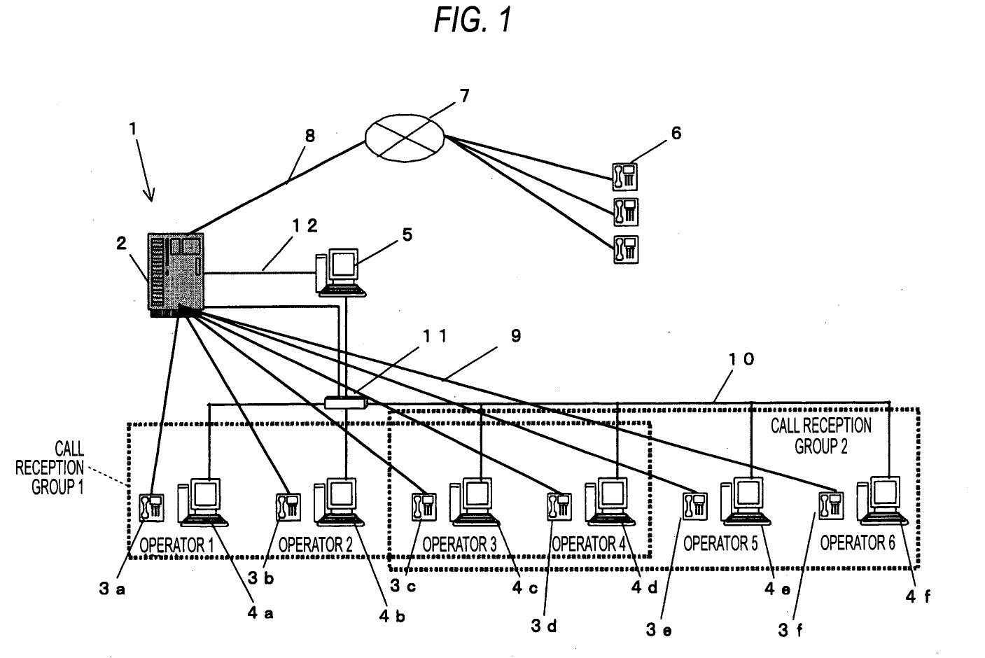

FIG. 1 is a view showing a configuration of a call center system which used a call center server and an operator terminal in an embodiment 1.

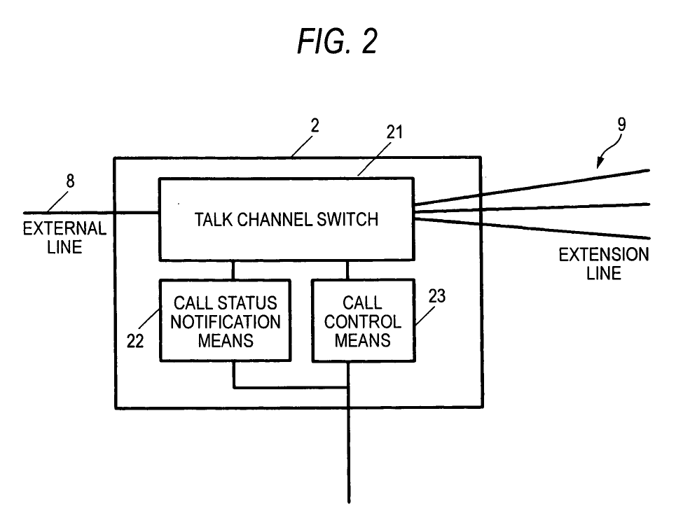

FIG. 2 is a view showing a configuration of an exchange of the call center system.

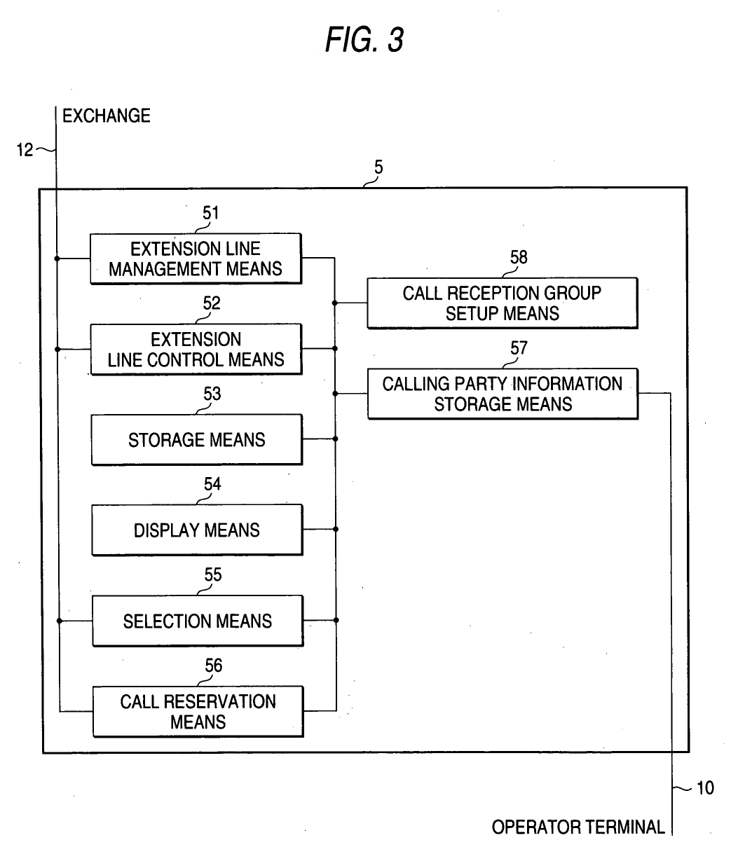

FIG. 3 is a view showing a configuration of a CCS server of the call center system.

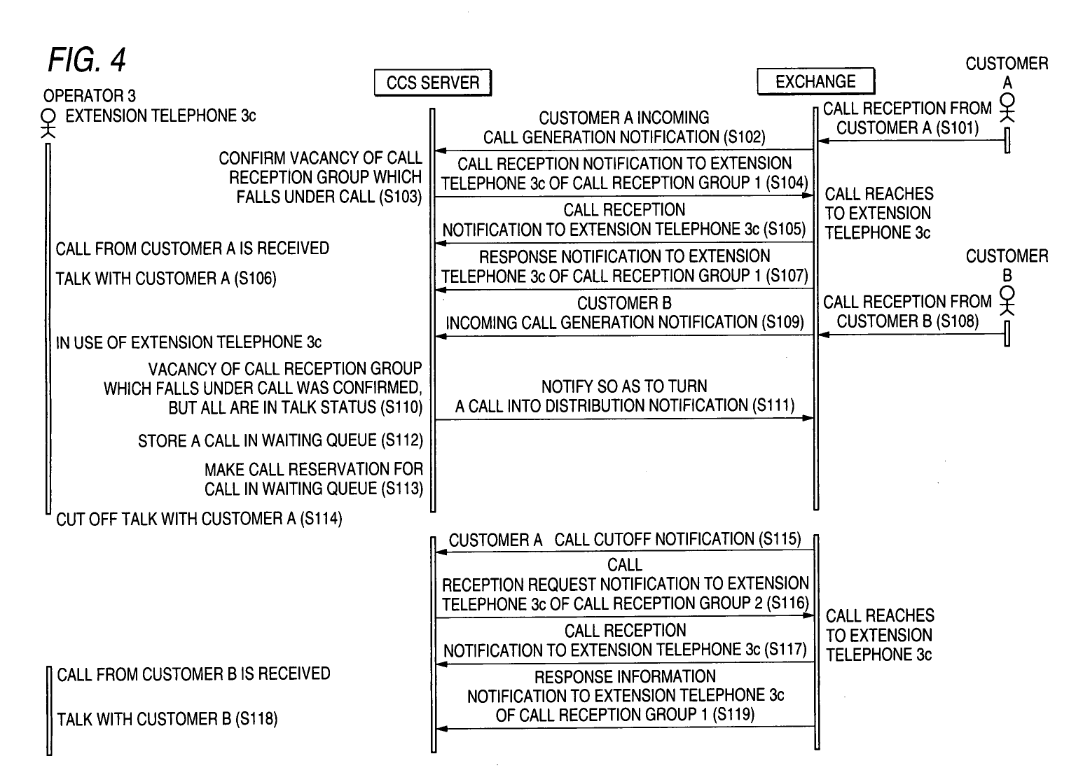

FIG. 4 is a view showing an operation of a call center system.

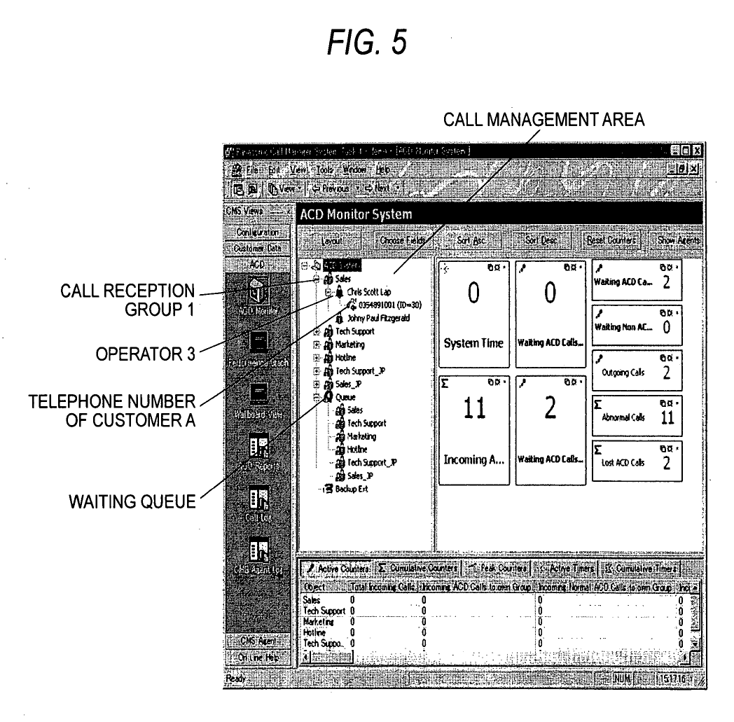

FIG. 5 is a view showing a display example of display means of the CCS server.

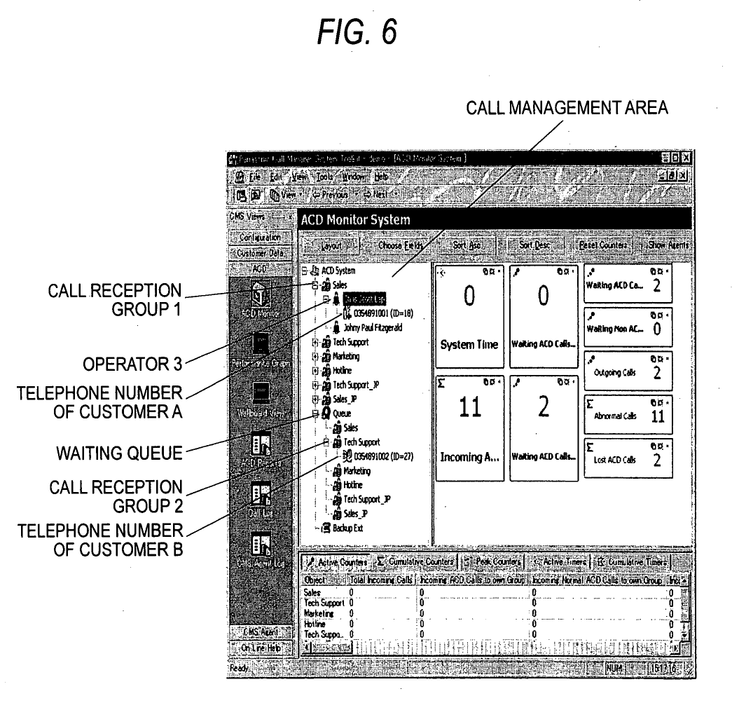

FIG. 6 is a view showing a display example of display means of the CCS server.

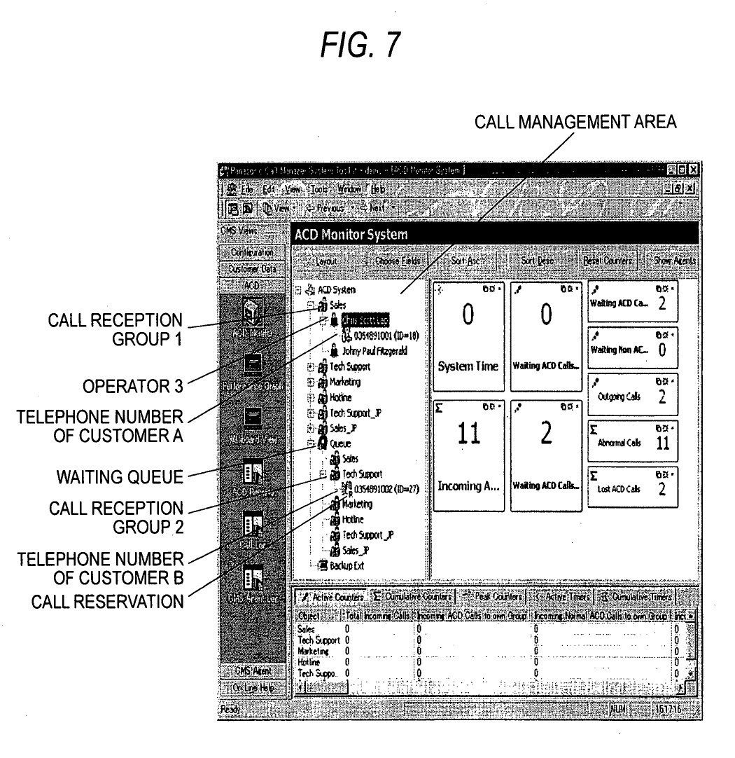

FIG. 7 is a view showing a display example of display means of the CCS server.

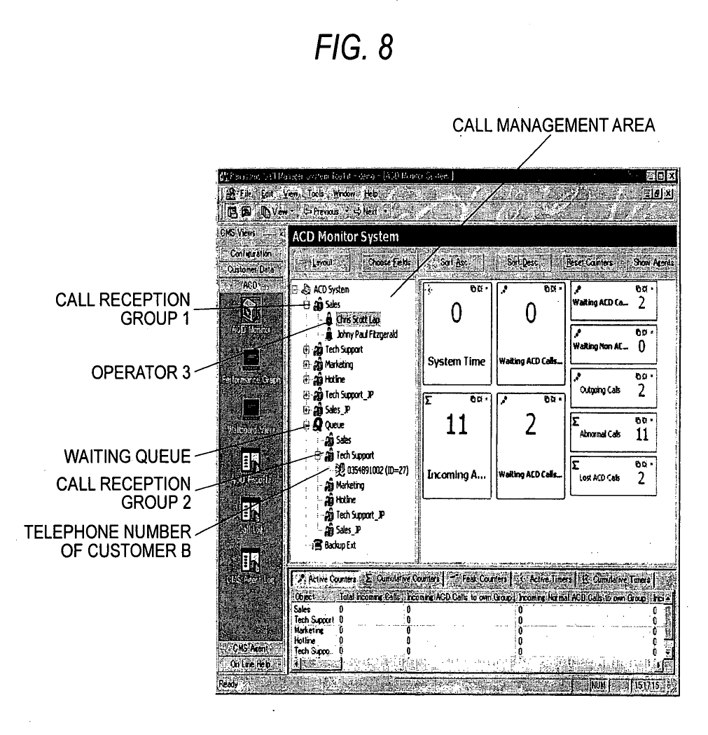

FIG. 8 is a view showing a display example of display means of the CCS server.

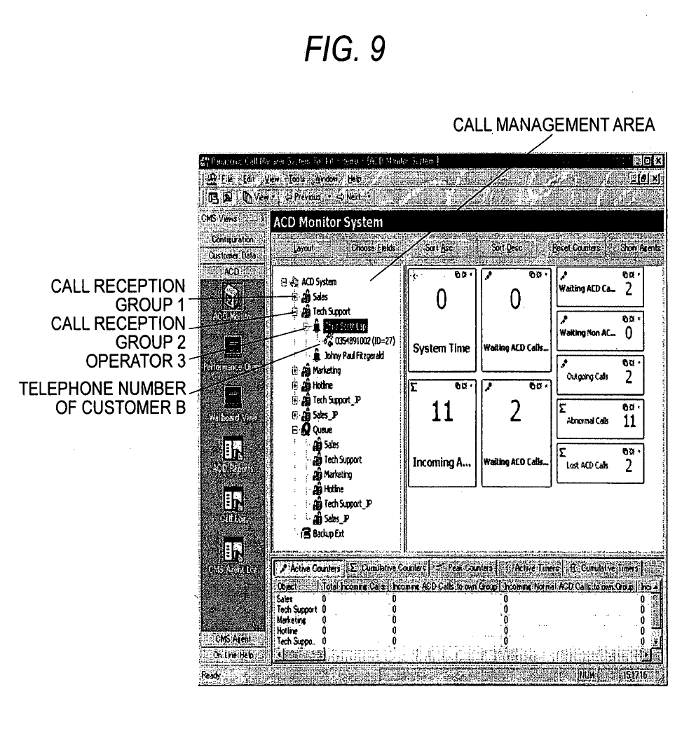

FIG. 9 is a view showing a display example of display means of the CCS server.

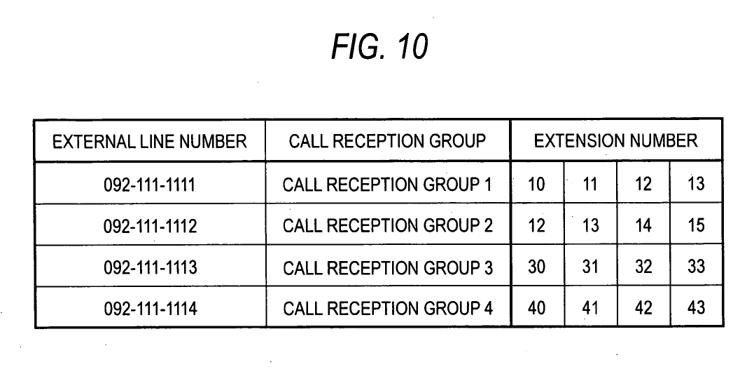

FIG. 10 is a view showing one example of setup content of call reception group setup means.

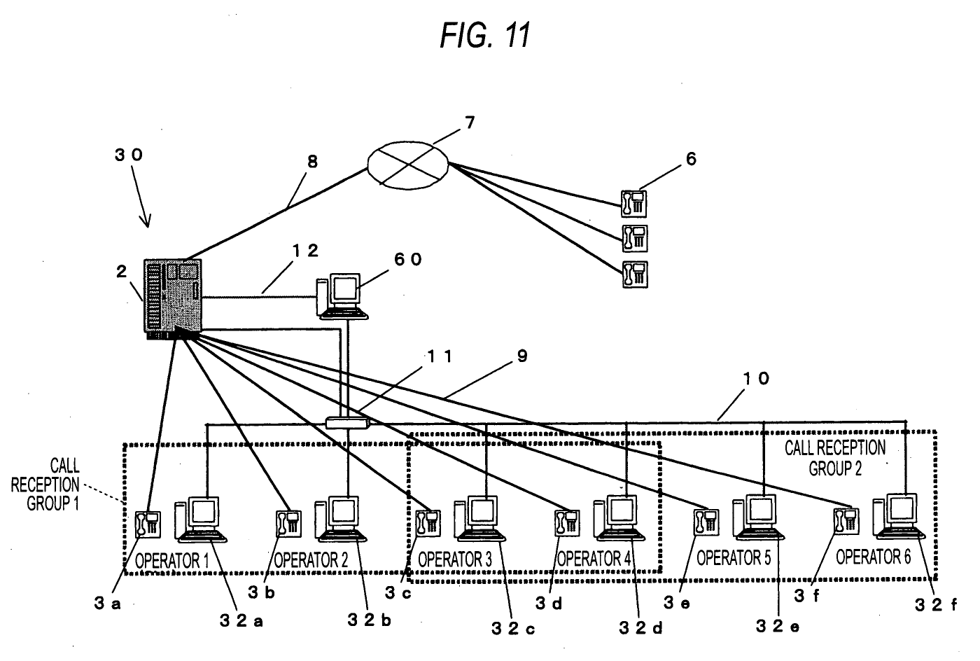

FIG. 11 is a view showing a configuration of a call center system in an embodiment 2.

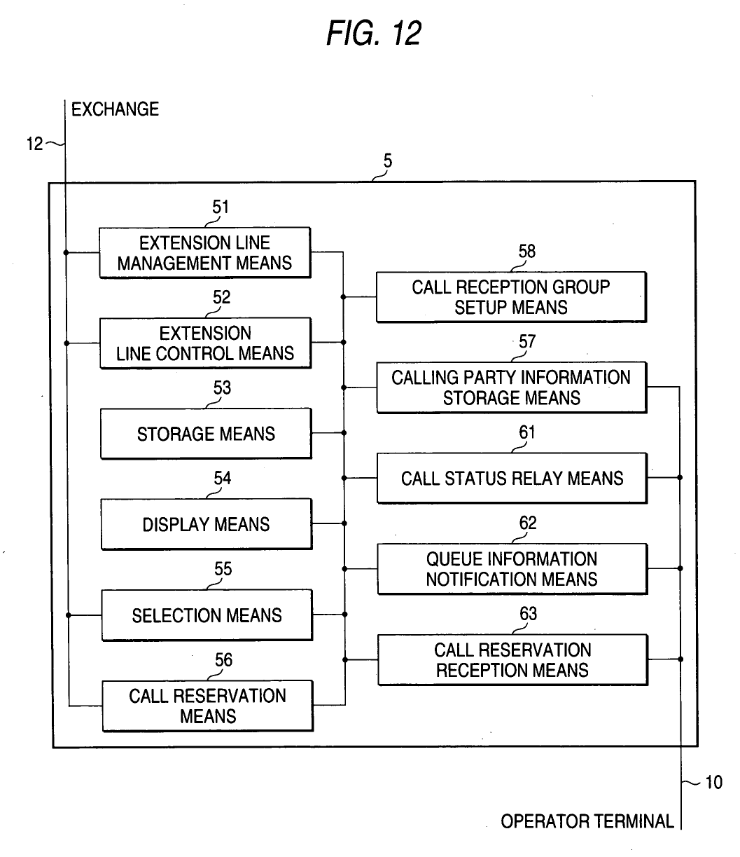

FIG. 12 is a view showing a configuration of a CCS server in the embodiment 2.

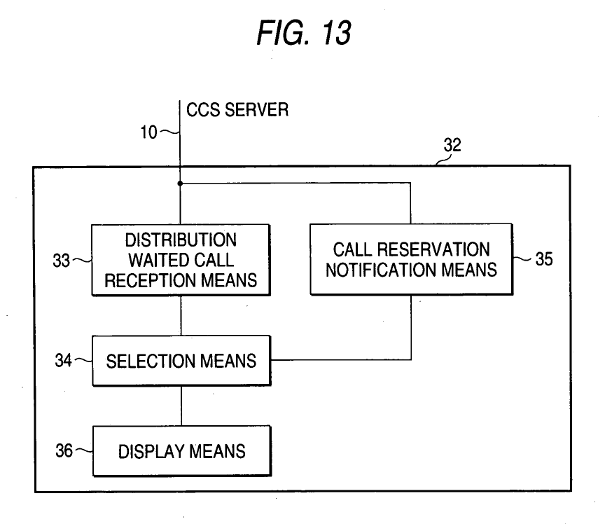

FIG. 13 is a view showing a configuration of an operator terminal in the embodiment 2.

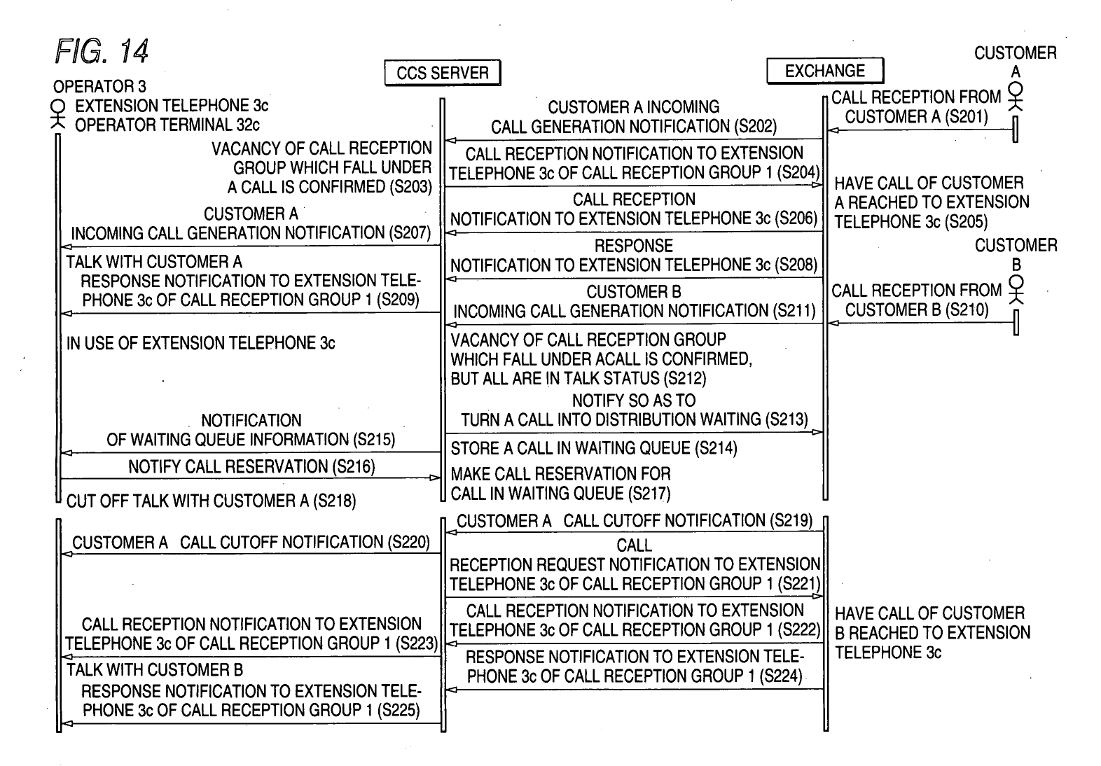

FIG. 14 is a view showing an operation of the call center system in the embodiment 2.

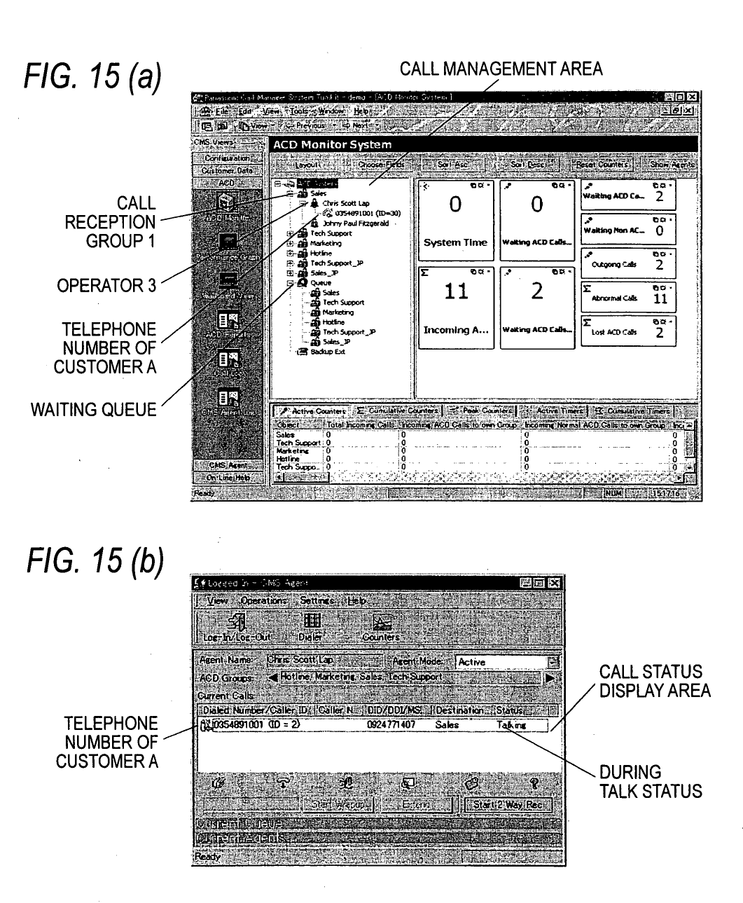

FIG. 15 is a view showing a display example of the CCS server and the operator terminal in the embodiment 2 of the invention.

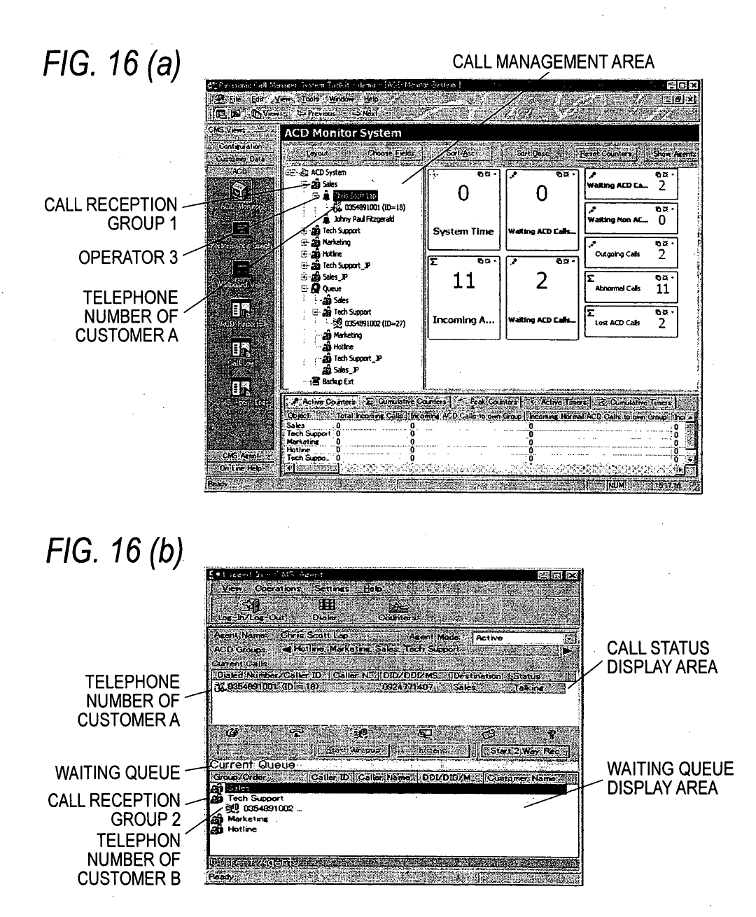

FIG. 16 is a view showing a display example of the CCS server and the operator terminal in the embodiment 2 of the invention.

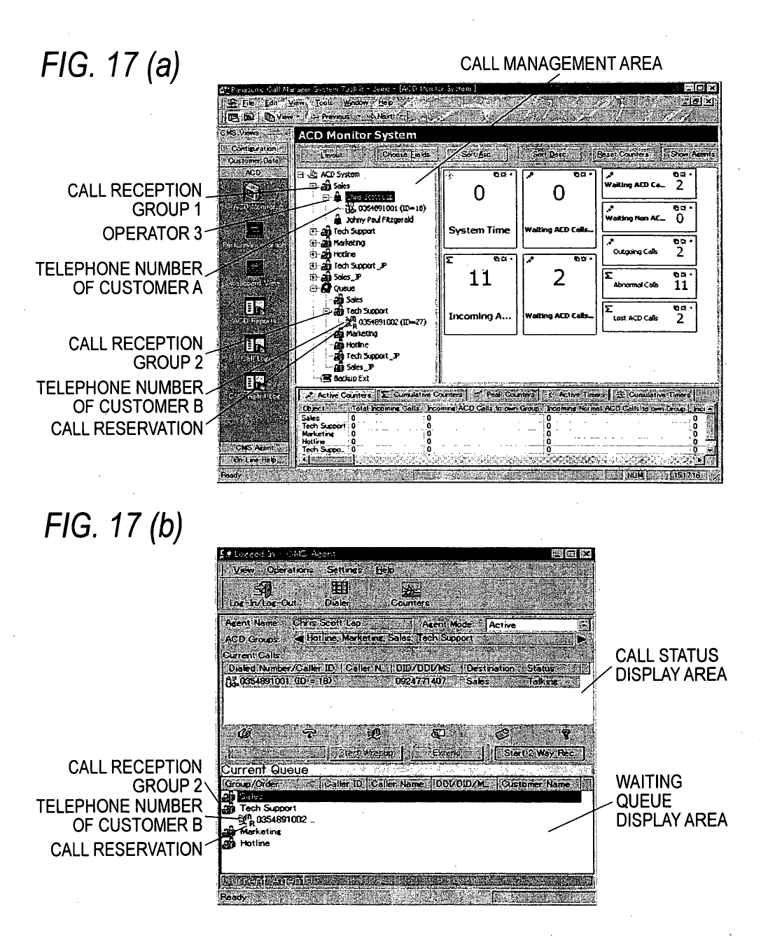

FIG. 17 is a view showing a display example of the CCS server and the operator terminal in the embodiment 2 of the invention.

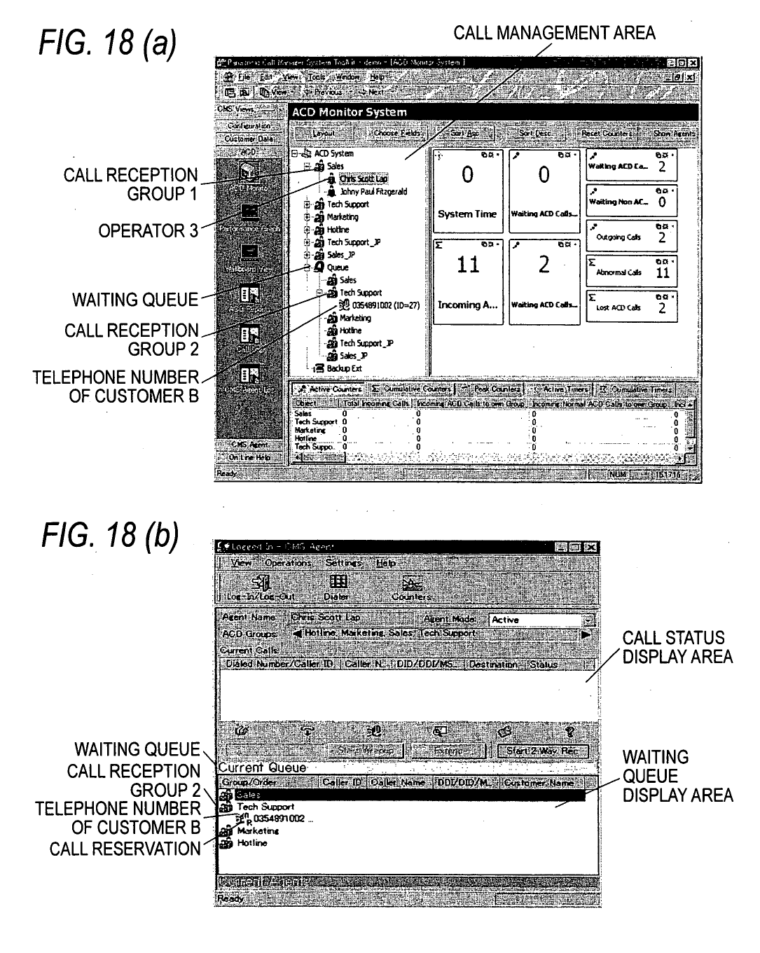

FIG. 18 is a view showing a display example of the CCS server and the operator terminal in the embodiment 2 of the invention.

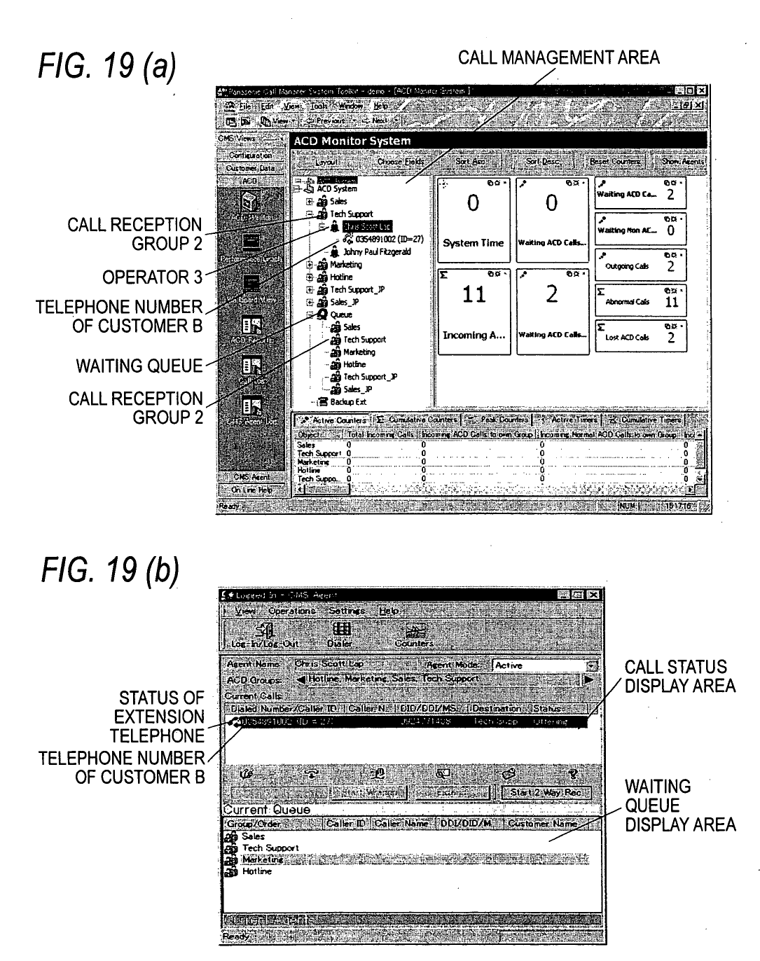

FIG. 19 is a view showing a display example of the CCS server and the operator terminal in the embodiment 2 of the invention.

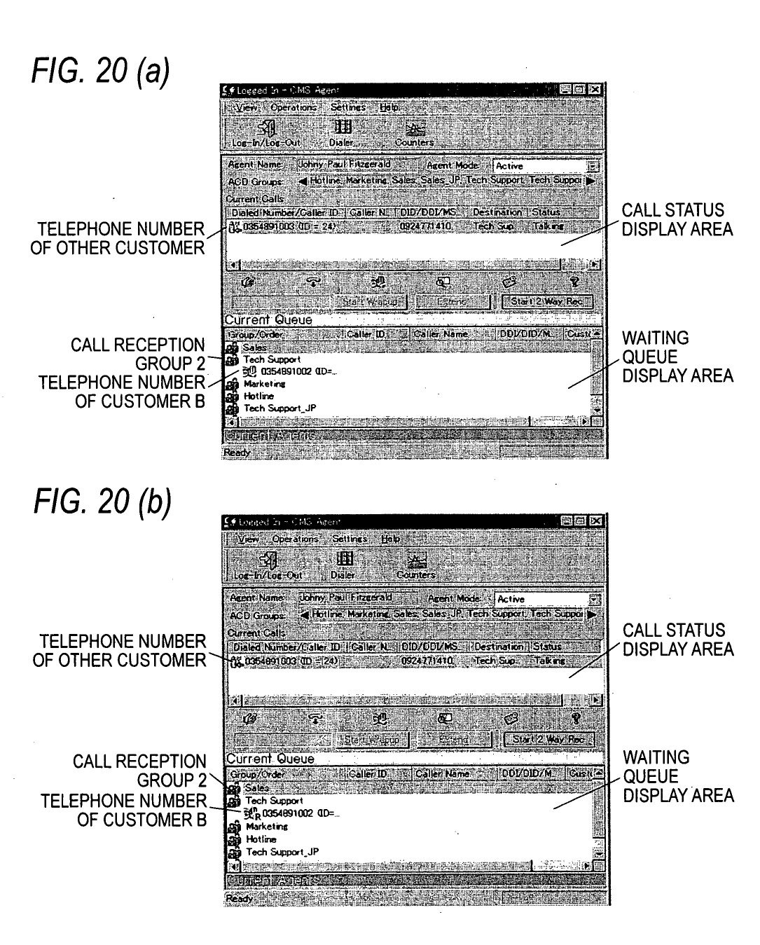

FIG. 20 is a view showing a display example of another operator terminal side which is not reserved for call.

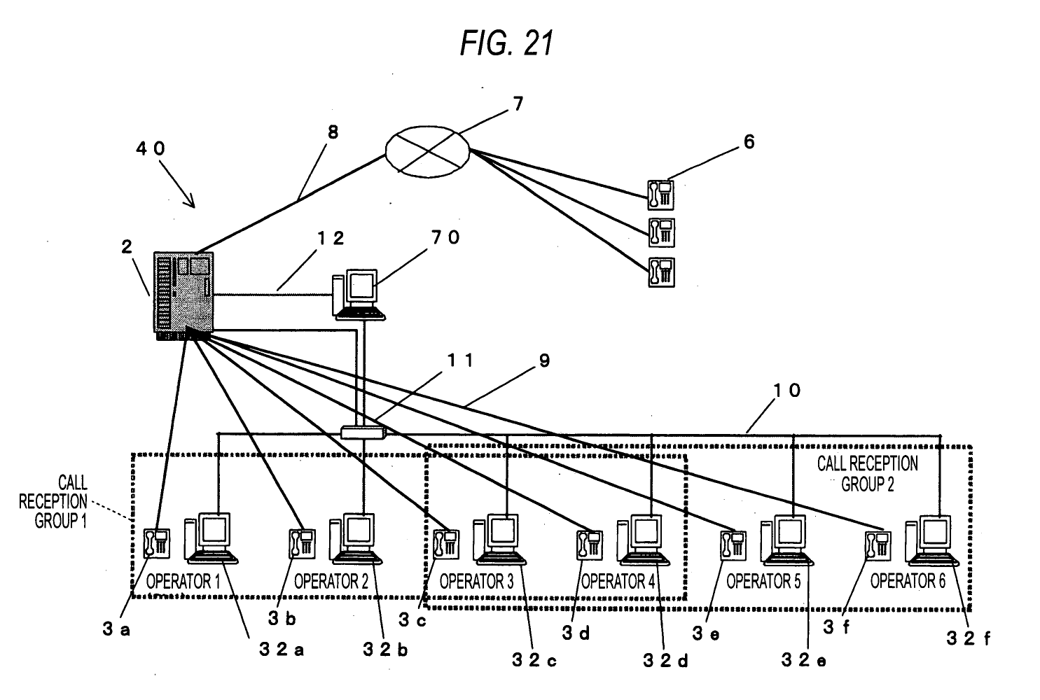

FIG. 21 is a view showing a configuration of a call center system in an embodiment 3.

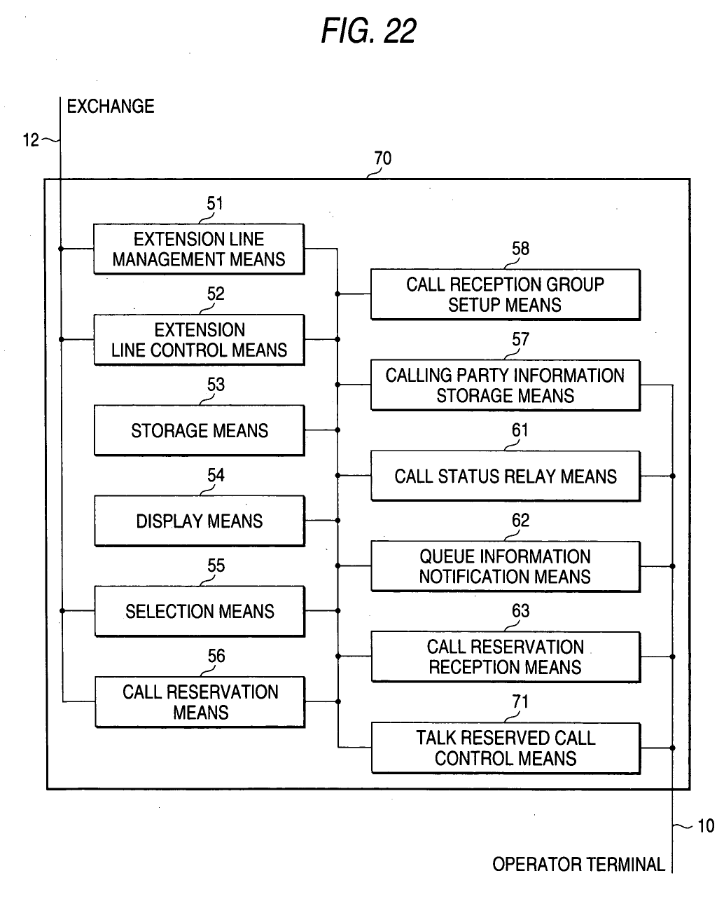

FIG. 22 is a view showing a configuration of a CCS server of the call center system in the embodiment 3.

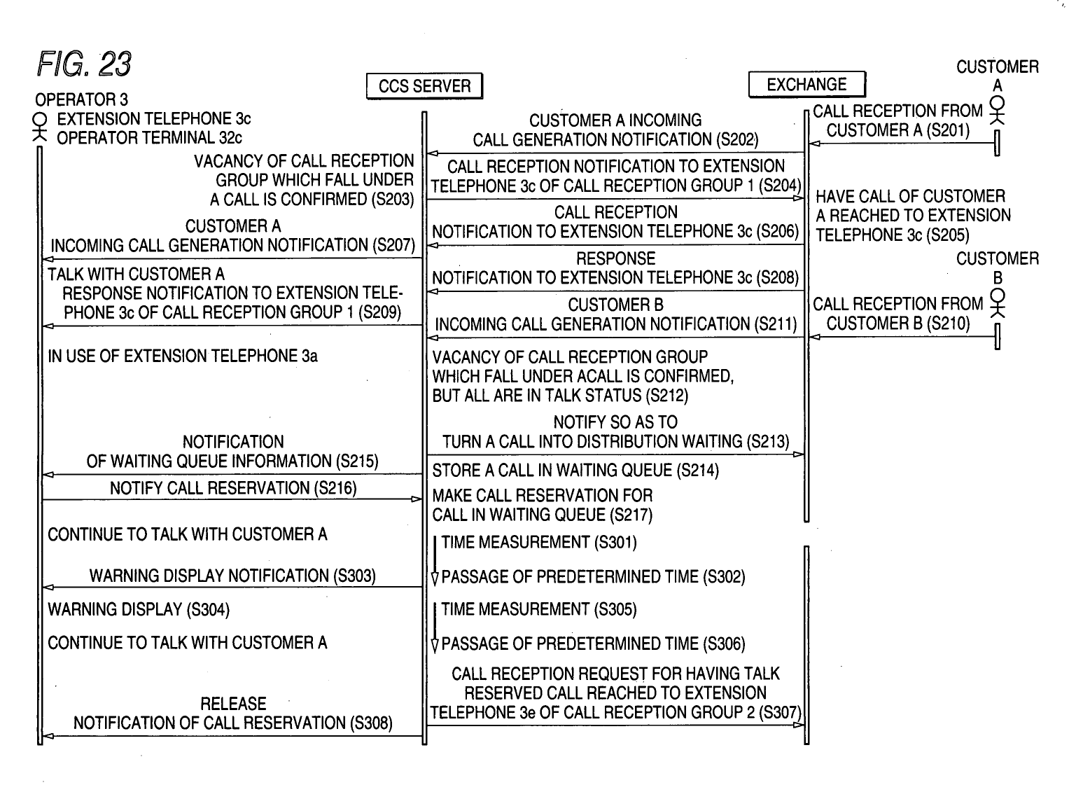

FIG. 23 is a view showing an operation of the call center system in the embodiment 3.

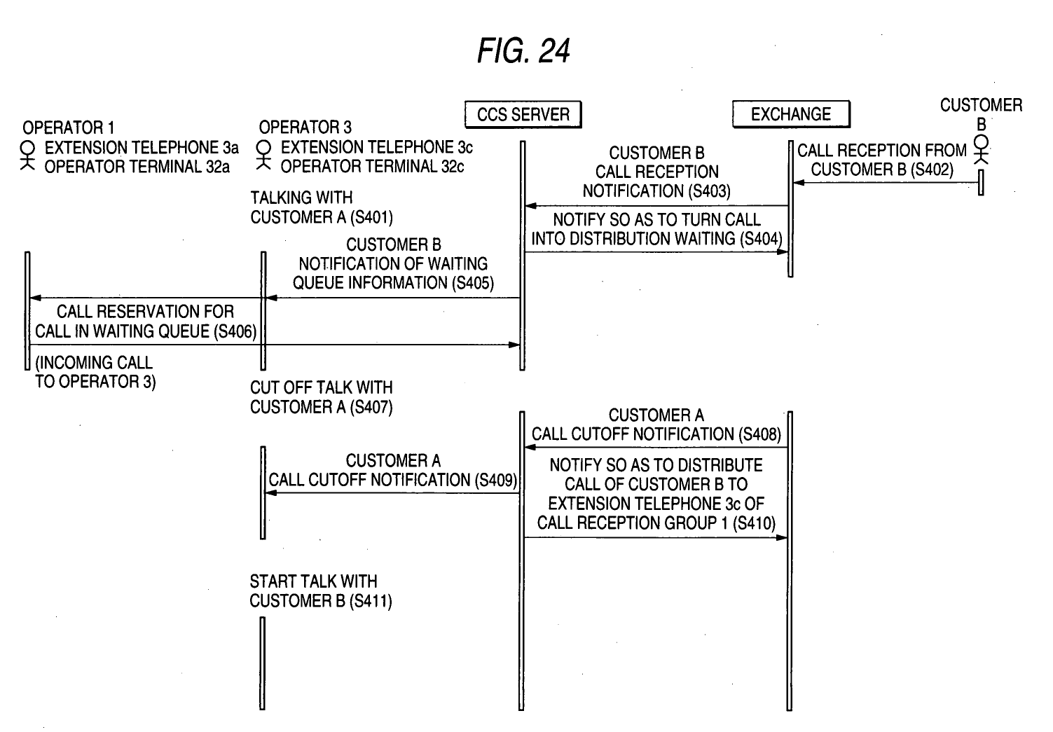

FIG. 24 is a view showing an operation of a call center system in an embodiment 4.

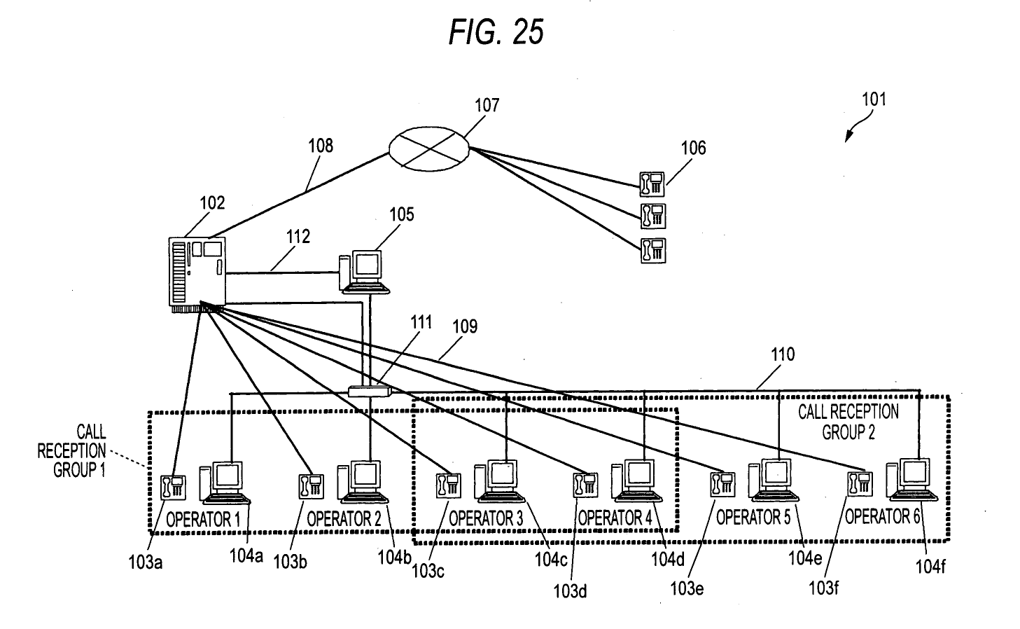

FIG. 25 is a block diagram of a call center system in an embodiment of the invention.

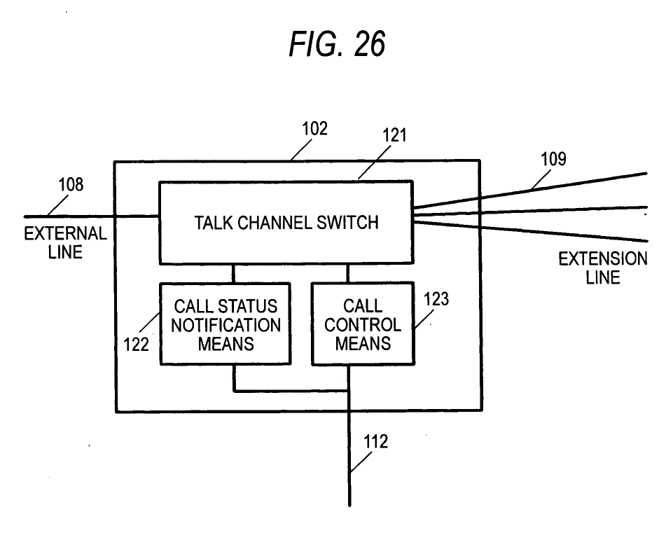

FIG. 26 is a block diagram of an exchange in FIG. 1.

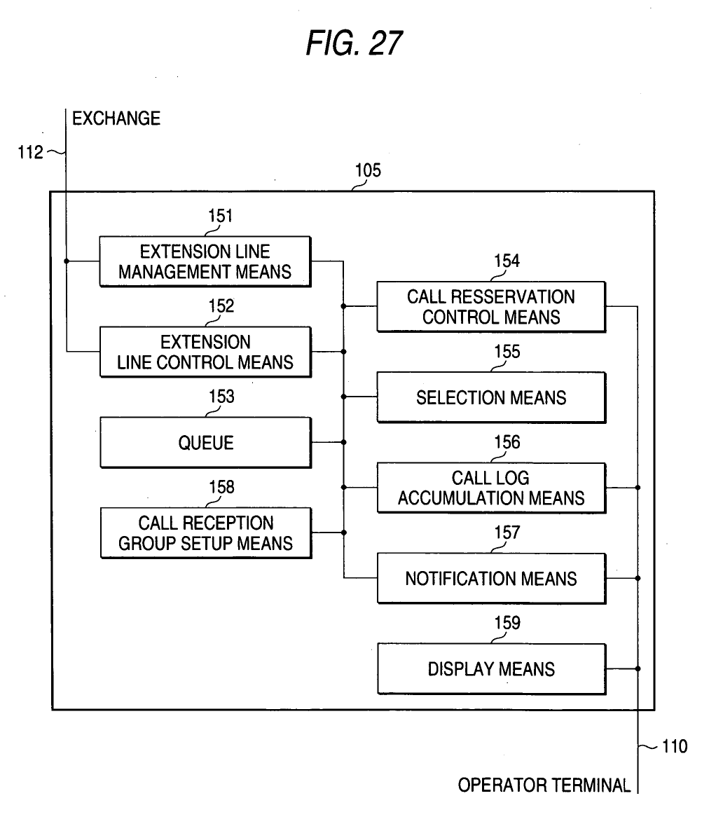

FIG. 27 is a block diagram of a CCS server in FIG. 1.

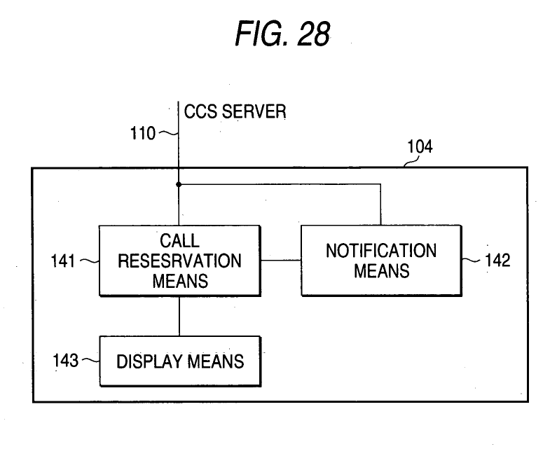

FIG. 28 is a block diagram of an operator terminal in FIG. 1.

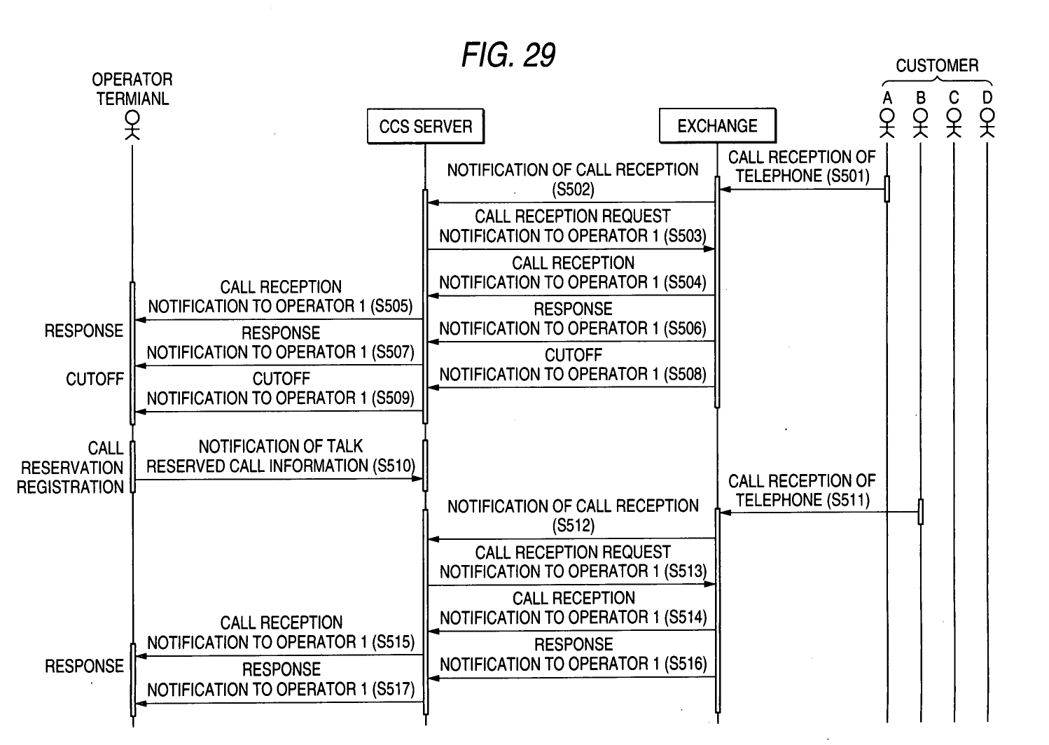

FIG. 29 is a view showing an operation of the call center system in FIG. 1.

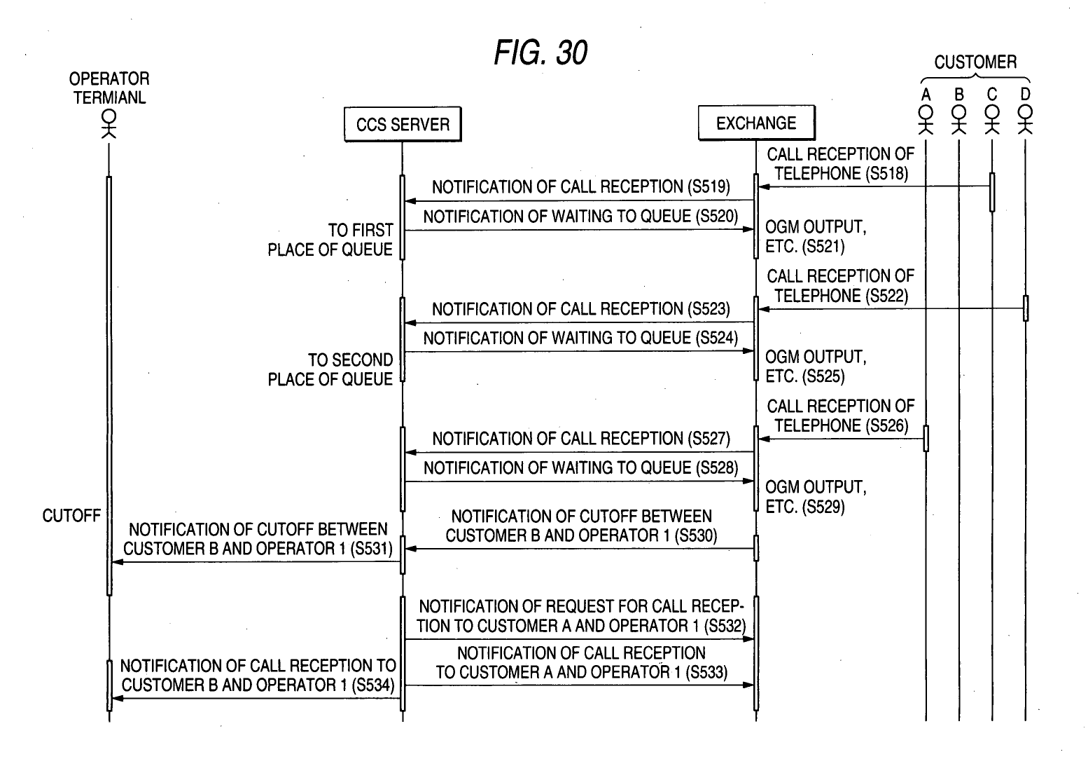

FIG. 30 is a view showing an operation of the call center system in FIG. 1.

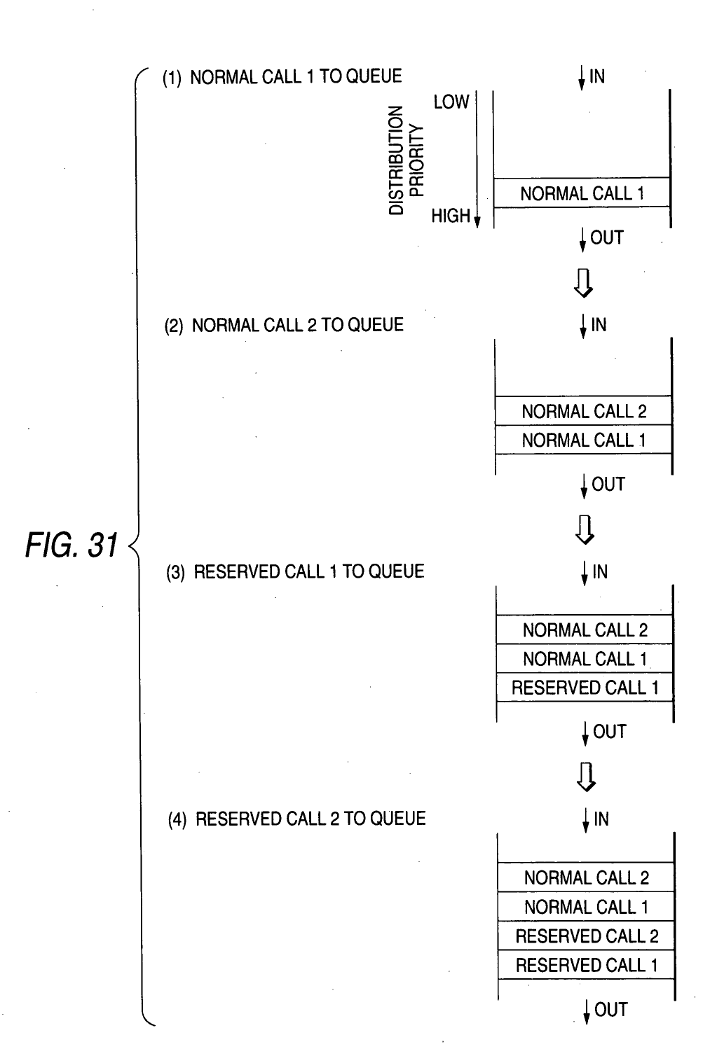

FIG. 31 is a view showing a queue operation.

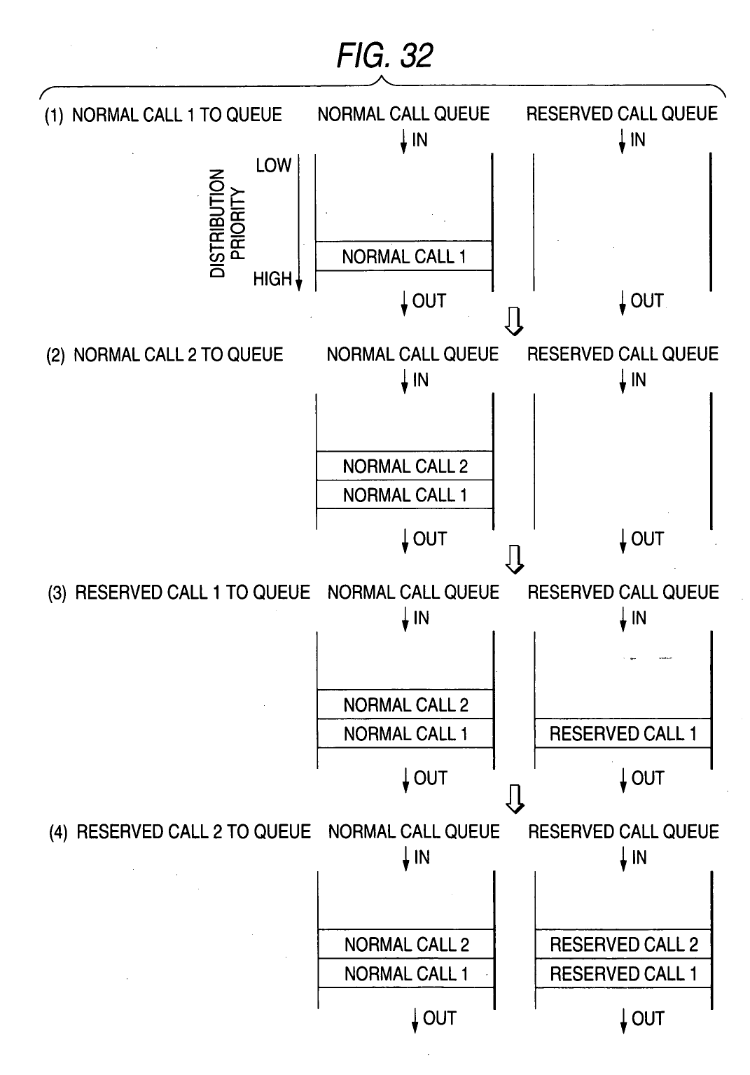

FIG. 32 is a view showing a queue operation.

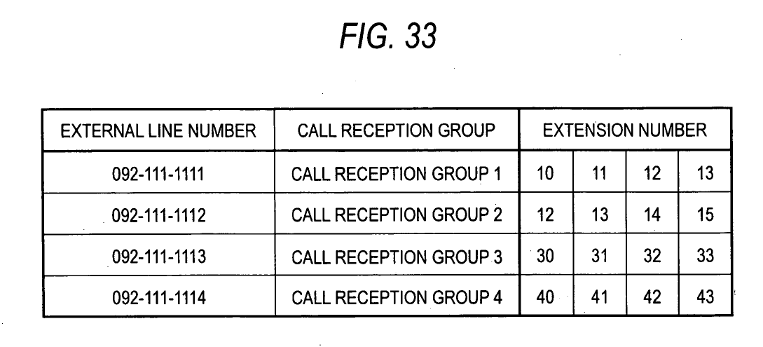

FIG. 33 is a view showing one example of setup content of call reception group setup means.

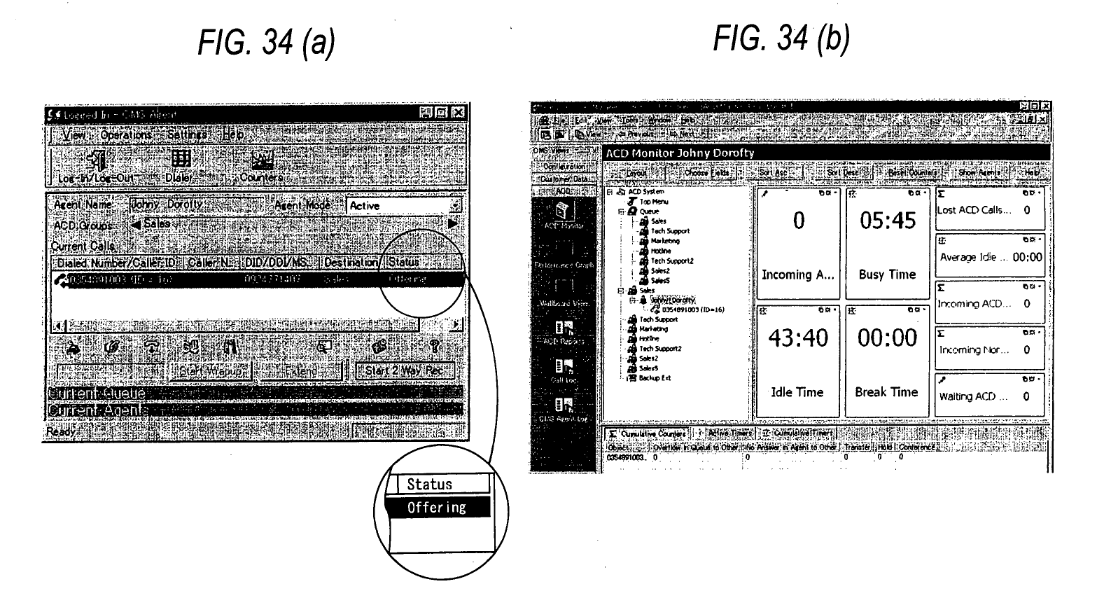

FIG. 34 is a view showing a display example of an operator terminal and a CCS server.

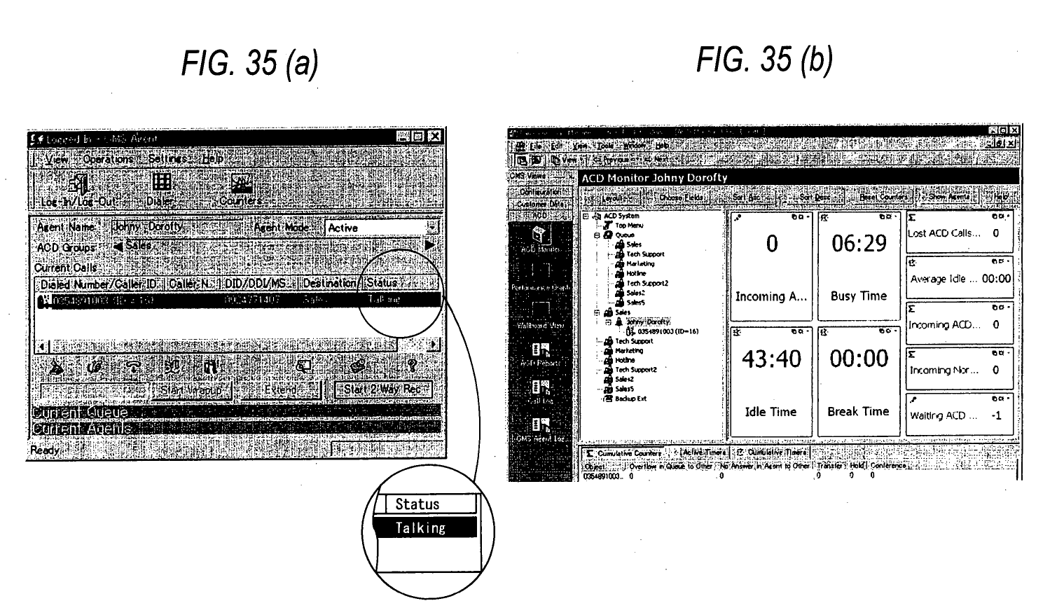

FIG. 35 is a view showing a display example of the operator terminal and the CCS server.

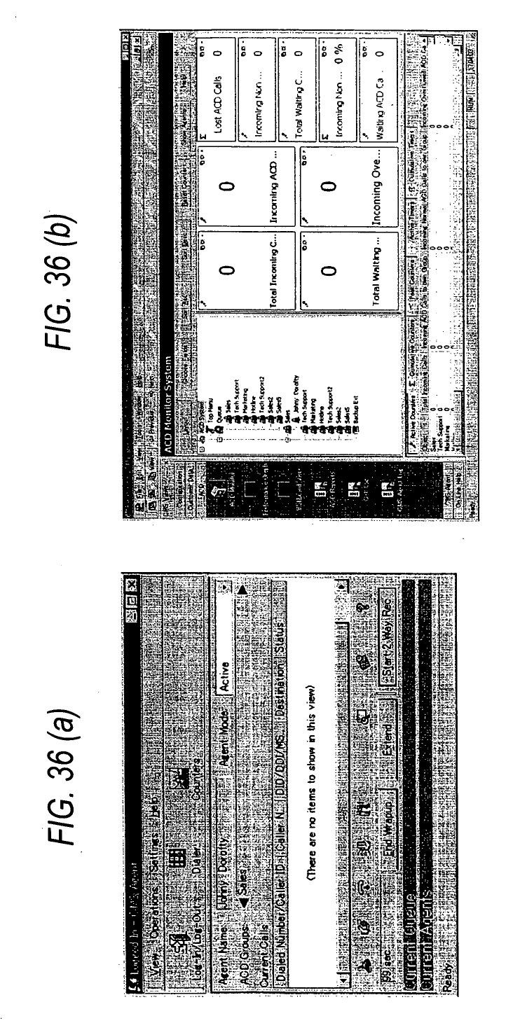

FIG. 36 is a view showing a display example of the operator terminal and the CCS server.

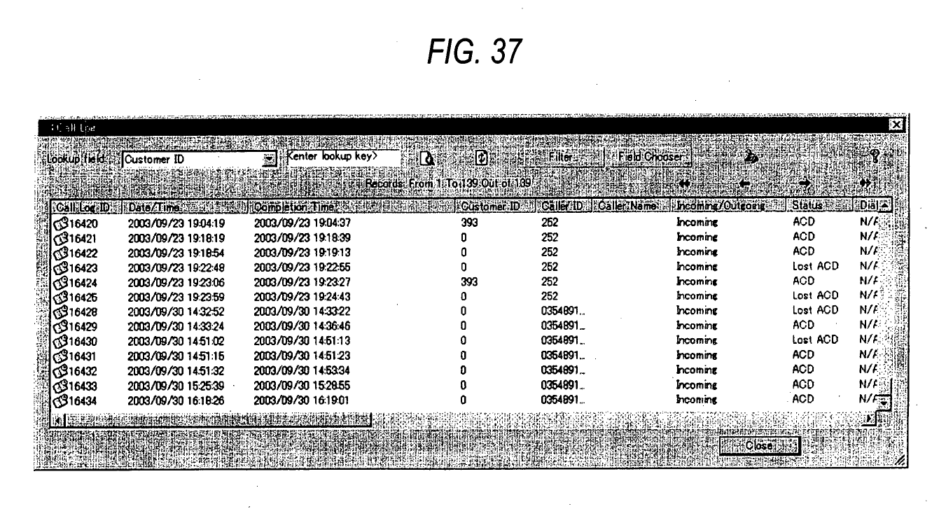

FIG. 37 is a view showing a display example of a call log which is displayed on an operator terminal.

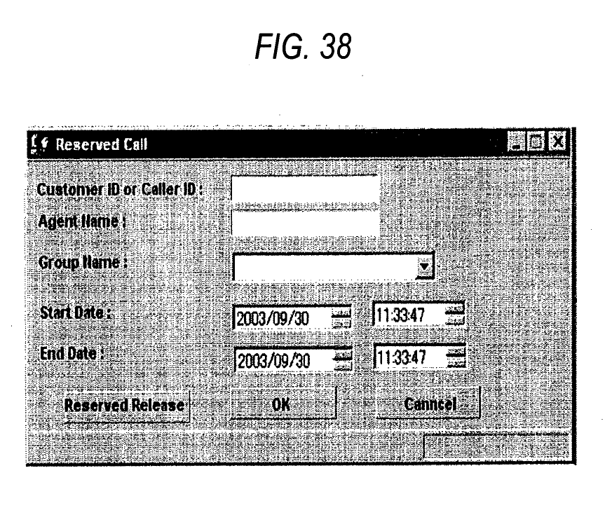

FIG. 38 is a view showing a display example of “a call reservation window” which is displayed on the operator terminal.

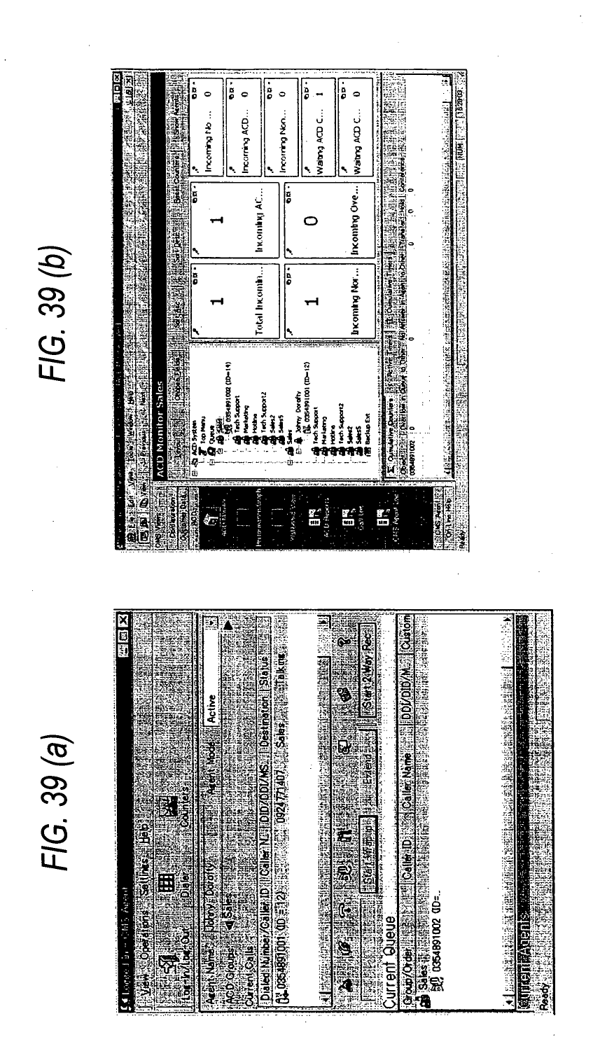

FIG. 39 is a view showing a display example of the operator terminal and the CCS server.

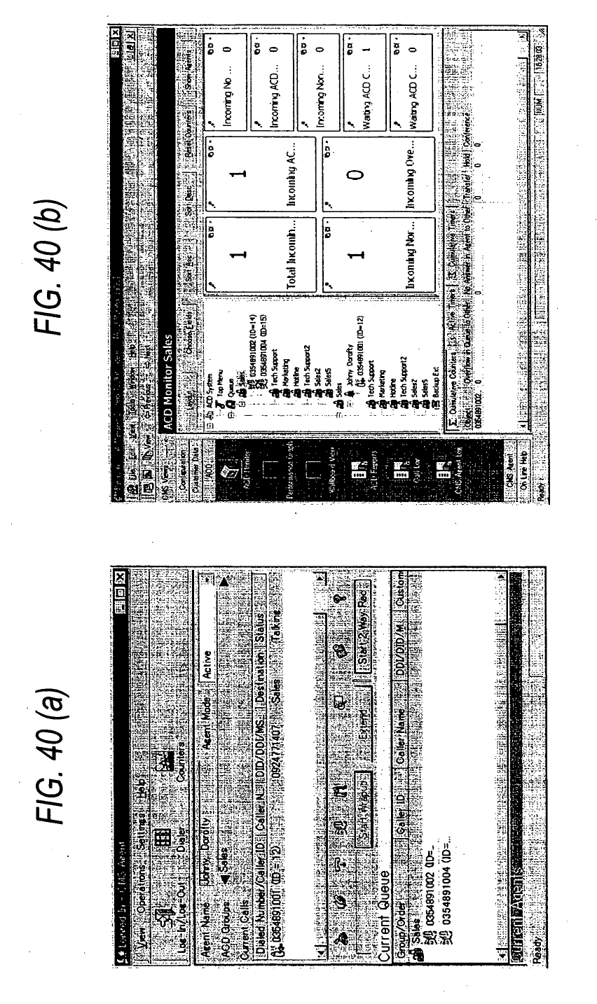

FIG. 40 is a view showing a display example of the operator terminal and the CCS server.

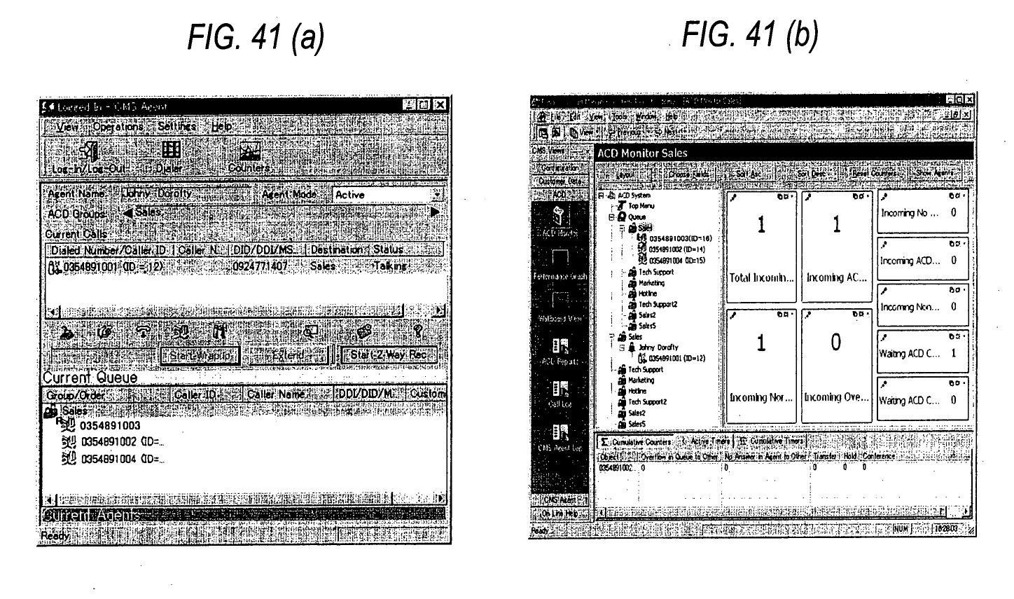

FIG. 41 is a view showing a display example of the operator terminal and the CCS server.

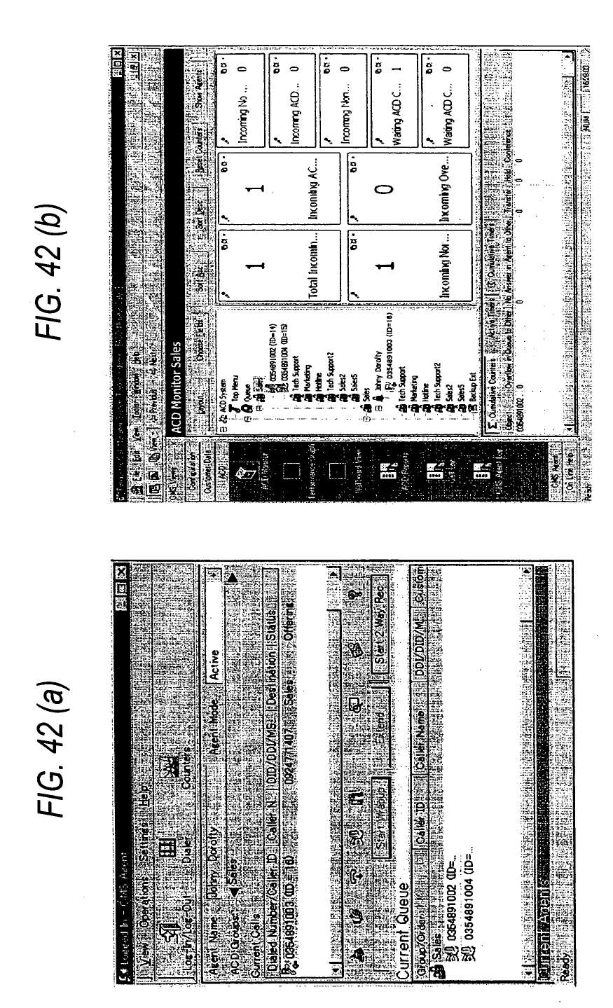

FIG. 42 is a view showing a display example of the operator terminal and the CCS server.

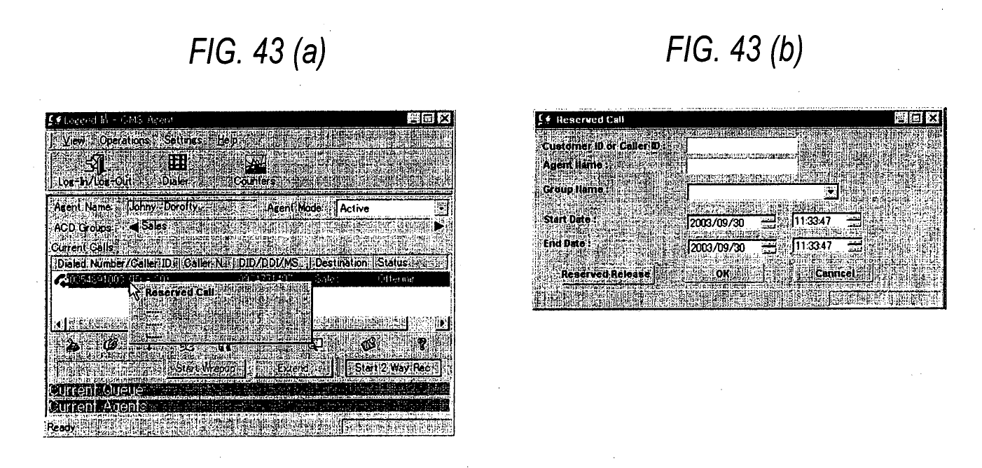

FIG. 43 is a view showing a display example on the occasion of making a call reservation during a period of call, which is displayed on the operator terminal.

### DESCRIPTION OF REFERENCE NUMERALS AND SIGNS

1 call center system

2 exchange

3, 3a˜3f extension telephone

4, 4a˜4f operator terminal

5 CCS server

6 customer telephone

7 general public network

8 external line

9 extension line

10 network

11 hub

12 control line

21 talk channel switch (channel switch)

22 call status notification means (call status notifier)

23 call control means (call controller)

30 call center system

32, 32a˜32f operator terminal

33 distribution waited call reception means (distributing queue receiver)

34 selection means (selector)

35 call reservation notification means (call reserved notifier)

36 display means (display)

40 call center system

51 extension line management means (extension line manager)

52 extension line control means (extention line controller)

53 storage means (memory)

54 display means (display)

55 selection means (selector)

56 call reservation means (call reserve)

57 calling party information storage means

58 call reception group setup means

60 CCS server

61 call status relay means

62 queue information notification means

63 call reservation reception means

70 CCS server

71 call reservation reception means

101 call center system

102 exchange

103, 103a˜103f extension telephone

104, 104a˜104f operator terminal

105 CCS server

106 customer side telephone

107 general public network

108 external line

108 extension line

110 network

111 hub

112 control line

121 talk channel switch

122 call status notification means

123 call control means

141 call reservation means.

142 notification means

143 display means

151 extension line management means

152 extension line control means

153 queue

154 call reservation control means

155 storage means

156 call log accumulation means

157 notification means

158 call reception group setup means

159 display means

### DETAILED DESCRIPTION OF THE PREFERRED EMBODIMENTS

(Embodiment 1)

A call center, which allows to receive a call on the occasion that a reception waited call from an external line became available to be received by an extension telephone which was associated with it by talk reserved call information, which is a first object, will be described as follows as an embodiment 1.

The call center system of the embodiment 1 of the invention will be described on the basis of FIG. 1 through FIG. 10. FIG. 1 is a view showing an overall configuration of the call center system of the embodiment 1, which used a call center server and operation terminals. FIG. 2 is a view showing a configuration of an exchange in FIG. 1. FIG. 3 is a view showing a configuration of a CCS server in FIG. 1. FIG. 4 is a view showing an operation of the call center system. FIG. 5 through FIG. 9 are views which show display examples of display means. FIG. 10 is a view showing one example of setup content of call reception group setup means.

Firstly, a configuration of the call center system of the embodiment 1 of the invention will be described on the basis of FIG. 1 through FIG. 3, and FIG. 10.

As shown in FIG. 1, a call center system 1 has an exchange 2, a plurality of extension telephones 3 (3a˜3f) which were allocated to respective operators, operator terminals 4 (4a˜4f), and a CCS server 5 which is a call center server (Call Center System Server) controlling the exchange 2 and the operator terminals 4.

In case that a call request of a customer telephone 6 was received from an external line 8 through a general public line 7 such as a subscriber telephone network and ISDN (Integrated Service Digital Network), the exchange 2 distributes the received call to the extension telephones 3 connected to extension lines 9.

In addition, the exchange 2 is connected to the operator terminals 4 and the CSS server 5 by a network 10 through a hub 11 which is a line concentrator. In addition, in case that the exchange 2 or the CCS server 5 is installed on a floor or in a building which is different from a room in which the operator terminal 4 was installed, communication is possible by connecting to it through a network relay device etc. such as a router.

The exchange 2 is connected to the CCS server 5 through a control line 12. As the control line 12, a general-purpose interface can be used. For example, it is possible to use LAN (Local Area Network) such as USB (Universal Serial Bus) and 100 Base-T, RS-232C by which bi-directional serial communication is possible, a bi-directional parallel interface etc. In addition, as a procedure of distributing information, it is possible to communicate by a procedure which conformed to CSTA (Computer Supported Telecommunication Applications) and a procedure of a specific protocol. The exchange 2 and the CCS server 5 carry out communication by the control line 12, but in case of carrying out communication through the use of the network 10, it is possible to omit the control line 12.

Next, a configuration of the exchange 2 in the call center system of the embodiment 1 will be described in detail on the basis of FIG. 2. As shown in FIG. 2, the exchange 2 has a talk channel switch 21, call status notification means 22, and call control means 23. The talk channel switch 21 is forming a talk channel by changing over a switch which connects a talk channel between the external line 8 and the extension line 9, and carries out switching by notification of the call control means 23.

In case that a call status in the talk channel switch 21 was changed, the call status notification means 22 notifies the status to the CCS server 5. For example, the call status notification means 22 transmits incoming call generation notification which shows that an incoming call was newly generated, when a call from the external line 8 was received, and transmits reception notification when the call from the external line was received by an extension telephone, and transmits response notification when the extension telephone 3 responds the distributed call from the external line, and transmits cutoff notification by which the call from the external line was cut off, to the CSS server 5.

The call control means 23 realizes a distribution waiting status and a receiving status which is such a status that a call from the external line 8 is prohibited to be received by any extension telephone 3, by notification from the CCS server 5, and carries out such control that a call is allowed to be received by the extension telephone 3 which was designated from the CCS server, by notifying to the talk channel switch 21.

Next, a configuration of the CCS server 5 in the call center system of the embodiment 1 of the invention will be described in detail on the basis of FIG. 3. As shown in FIG. 3, the CCS server 5 has extension line management means 51, extension line control means 52, storage means 53, display means 54, selection means 55, call reservation means 56, calling party information storage means 57, and call reception group setup means 58.

The extension line management means 51 manages each status of a waiting status in which a call can be received and a talking status in which a call can not be received, as an extension line status, from content of call reception notification or cutoff notification from the exchange 2. In case that there was call reception notification showing that a call from the external line 3 was received by the extension line telephone 3 which is in a waiting status where a call can be received, an extension line status of this extension telephone 3 is turned into a talking status in which a call can not be received. In addition, in case that there was cutoff notification that the extension telephone 3, which is in a talking status, was cut off, from the exchange 2, the extension line status is turned into a waiting status in which a call can be received.

In addition, the extension line management means 51 manages the extension telephones 3 and the operator terminals 4 in association with each other. For example, the extension telephone 3a and the operator terminal 4a which the same operator uses, the extension telephone 3b and the operator terminal 4b, the extension telephone 3c and the operator terminal 4c, the extension telephone 3d and the operator terminal 4d, etc. are associated with each other.

The extension line control means 52 judges and determines an call reception group and the extension telephone 3 which belongs to the call reception group, with reference to call reception group setup means 58 from incoming call generation notification from the exchange 2, and in case that the extension telephone 3 of a call reception destination is available to receive a call due to the extension line status of the extension line management means 51, it notifies to call control means 23 of the exchange 2 so as to allow the extension telephone 3 at a call reception destination to receive a call, and in case that a call can not be received, it notifies to the call control means 23 of the exchange 2 so as to turn a call into a distribution waiting status, and it stores data which identifies calls in storage means 53 as distribution waiting information.

For example, in case that a call from the external line 8 is addressed to the extension telephone 3a, the extension line control means 52, which received incoming call generation notification addressed to the extension telephone 3a from the exchange 2, judges and determines an call reception group and the extension telephone 3a which belongs to the call reception group, with reference to the call reception group setup means 58, and refers to an extension line status of the extension telephone 3a of the extension line management means 51. Then, if it is in a talking status, a call can not be received, and therefore, it is notified to call control means 23 of the exchange 2 so as to be turned into a distribution waiting status, and data, which identifies calls from the external line 8, is stored in the storage means 53 as distribution waited call information. If a talking status of the extension telephone 3a is a waiting status in which a call can be received, call reception request notification is notified to the call control means 23 of the exchange 2 so as to be received by the extension telephone 3a.

As the data which identifies, it is possible to use, for example, calling party telephone numbers of calling parties, customer ID allocated with respect to each customer, identification ID to be allocated continuously in the order corresponding to incoming calls by the CCS server 5 on the occasion that there were incoming calls. In addition, the extension line control means 52 has a function as call reception notification means for notifying release of a distribution waiting status of a call and reception of a call by the extension telephone 3 at the call reception destination, to the exchange 2, in case that the extension telephone 3, which is a call reception destination of a call which was reserved, became available to receive a call.

Meanwhile, as to an explanation regarding an call reception group, similar content is described in open information (2002-2248353 U.S. Publication No.), and therefore, an explanation will be omitted by quoting an open document.

The storage means 53 is equipped with waiting queues with respect to each call reception group by use of data which identifies calls which were turned into a distribution waiting status since it is not possible to receive a call, as distribution waited call information, and stores them in the order corresponding to incoming calls. This waiting queue is to be provided with respect to each call reception group, but it is possible to store distribution waited call information regardless of call reception group as one waiting queue, by adding information which identifies call reception groups to a distribution waited call.

The display means 54 has a function for displaying displays of content of the storage means 53, an extension line status of the extension line management means 51, talk time of each operator, the number of talks etc. As a display section of the display means 54, it is possible to use LCD (Liquid Crystal Display), CRT (Cathode Ray Tube) etc.

The selection means 55 has a function for selecting one or more calls from the external line, which were stored in the storage means 53 are in a distribution waiting status in which it is not possible for an extension telephone to receive a call, and for selecting a call reception destination of the selected call from the external line from the extension telephones 3a˜3f to set it up as a call reservation destination. The selection means 55 displays content of the storage means 53 on the display means 54, and selects a call from the external line 8, which is in a distribution waiting status since a call can not be received by the extension telephone 3, and the extension telephones 3a˜3f by which a call is desired to be received, through the use of input means such as a mouse and a keyboard which are not shown in the figure.

The call reservation means 56 stores the extension telephone 3 which was selected by the selection means 55 and by which a call in a distribution waiting status is desired to be received, in association with a call reservation destination, as talk reserved call information, in the storage means 53. In addition, the call reservation means 56 releases association of a distribution waited call which was set up as talk reserved call information by which a call was reserved, with the extension telephone 3 which is a call reservation destination, and thereby, it is also possible to make it a normal distribution waited call.

The calling party information storage means 57 stores calling party information such as names, addresses, ages, content of talks of calling parties, in association with calling party telephone numbers of calls from the external line 8. In this manner, if calling party information is displayed with reference to the calling party information storage means 57 on the occasion of accumulating calling party information of customers whom a call center dealt with, in the calling party information storage means 57, it is possible to easily get hold of information of customers whose calls are in distribution waiting status. As to an input of this calling party information, it is all right even if it is inputted from the CCS server 5, and it is also all right even if it is notified to the CCS server 5 through the network 10 every time an operator deals with a customer from each operator terminal 4 and it is stored in the calling party information storage means 57 by the CCS server 5.

The call reception group setup means 58 stores such setup that telephone numbers of extension lines were grouped corresponding to calls from the external line. For example, the grouped extension numbers are made to correspond to telephone numbers of an external line which a caller dialed (external line which received a call), telephone numbers of callers, call reception lines of a plurality of the external lines 8. FIG. 10 shows setup content of call reception groups which corresponded to telephone numbers of external lines which callers dialed, as one example thereof As shown in FIG. 10, an external line “092-111-1111” corresponds to a call received by an call reception group 1, and therefore, the call is received by any one of extension numbers “11”˜“13” which were allocated to the extension telephones 3a through 3d.

In addition, an external line “092-111-1112” corresponds to a call received by an call reception group 2, and therefore, the call is received by any one of extension numbers “12”˜“15” which were allocated to the extension telephones 3c through 3f. In this case, the extension telephone 3c and the extension telephone 3d belong to both of the call reception groups 1 and 2, and therefore, if they are in a waiting status in which a call can be received, a call from a customer, which was received through the external line “092-111-1111”, or the external line “092-111-1112”, is to be received by the extension telephone 3c or the extension telephone 3d.

Meanwhile, the storage means 53, which was described above, is configured by a memory having required memory capacity. Further, each of the extension line management means 51, the call reservation means 56, the calling party information storage means 57, and the call reception group setup means 58 is realized as a storage area which was ensured in the storage means 53. For example, when a certain specific one, out of data of a call log which was stored in the storage means 53, is selected by the selection means 55, a flag, which shows that a call reservation was setup in the data of a call log, is stored, and thereby the call reservation means 56 is realized.

Here, a method of the extension line control means 52 distributing to which extension number in an incoming groups will be described. In this embodiment, a call can be received, and is to reach to an small (young) extension number in an call reception group, but other than that, there is a method of distributing an incoming call from an external line to an extension number through which a call can be received, in a relevant call reception group.

(1) A call is made to always reach to the largest extension number in an call reception group.

(2) A call is made to reach to a smaller extension number than an extension number to which a call reached previous time. On that occasion, in case that the extension number to which a call reached previous time is the smallest, distribution is carried out from the largest extension number (round robin system in which allocation is carried out in descending order).

(3) A call is made to reach to a larger extension number than the extension number to which a call reached previous time. On that occasion, in case that the extension number to which a call reached previous time is the largest in an call reception group, distribution is carried out from the smallest extension number (round robin system in which allocation is carried out in ascending order).

(4) A call receiving order is set up in the call reception group setup means 58, and a call is made to be received in that order.

(5) In the extension line management means 51, disposed is a management table of talk time of each extension telephone 3, and a call is made to be received in the order corresponding to an extension number in which vacant (talk available) time is the longest.

(6) The setup order of (4) is set up to the order corresponding to an operator being recognized to have high skill.

(7) The setup order of (4) is set up to the order corresponding to an operator being recognized to have low skill.

(8) In the extension management means 51, disposed is a management table of the number of responses in each extension telephone 3, and a call is made to be received in the order corresponding to smaller response number.

(9) In the extension management means 51, disposed is a management table of talk time of each extension telephone 3, and a call is made to be received in the order corresponding to shorter talk time.

(10) A call is made to each to all extension telephones in an call reception group.

By properly selecting the suchlike call receiving order, effective distribution of incoming calls, which matched with various business categories, becomes possible.

The operator terminals 4 (4a˜4f) has a function of carrying out display of calling party information of calls which were received by respective extension telephones 3 (3a˜3f), and of inputting information such as inquiries and complaints from customers, content of talks such as replies to customers and transmitting them to the CCS server 5. In this embodiment 1, it is configured to have the operator terminals 4 (4a˜4f) in order to boost convenience of an operator, but, in particular, in case that the above-described function is unnecessary, it is all right even if a call center system with such a configuration that it was omitted is realized.

Next, an operation of the call center system in the embodiment 1 of the invention will be described on the basis of FIG. 1 through FIG. 9. As shown in FIG. 4, firstly, a call from a customer A reached to the exchange 2 (S101).

The call status notification means 22 of the exchange 2 transmits incoming call generation notification of the call from the customer A, to the CCS server 5 (S102).

When the extension line control means 52 of the CCS server 5 receives the incoming call generation notification from the exchange 2, it searches the extension telephones 3 which are available to receive a call, with reference to an call reception group to the call from the customer A, the extension line 9 which belongs to that call reception group, and a talk status of the extension telephone which is connected to that extension line 9, from content of the call reception group setup means 58 and an extension line status of the extension line management means 51. In this case, the call from the customer A is an incoming call to the call reception group 1, and an extension telephone, which is available to receive a call at that time, is to be the extension telephone 3c (S103).

The extension line control means 52 notifies an extension number of the extension telephone 3c as call reception request notification to the call control means 23 of the exchange 2, so as to have the call from the customer A reached to the extension telephone 3c (S104).

The call control means 23 of the exchange 2, which received the call reception request notification in order to have the call from the customer A reached to the extension telephone 3c, notifies it to the talk channel switch 21 so as to have the call reached to the extension telephone 3c, and sounds the extension telephone 3c. Then, the call status notification means 22 transmits such call reception notification that a call was received by the extension telephone 3c, to the CCS server 5. The extension line management means 51 of the CCS server 5, which received the notification, makes an extension line status of the extension telephone 3c a talk status in which a call can not be received (S105).

An operator, who is in charge of the extension telephone 3c, hooks up the extension telephone 3c, and starts a talk with the customer A (S106). The call status notification means 22 of the exchange 2 notifies response notification showing that the call from the customer A was responded by the extension telephone 3c, to the CCS server 5 (S107).

In S107, a display example of the CCS server at the time when the call from the customer A was responded by the extension telephone 3c will be described on the basis of FIG. 5. As shown in FIG. 5, on a screen of the display means 54, extension line statuses of respective extension telephones 3, and content of waiting queue of the storage means 53 are displayed in a window having a call management area hierarchized in such a manner that an upper layer was set up as an call reception group and a lower layer was set up to operators who belong to that call reception group.

A calling party telephone number of the customer A is displayed on “Chris” which is an operator 3 belonging to “Sales” which is the call reception group 1 of the call management area, and thereby, it shows talking with the call from the customer A. The extension line control means 52 displays this on the display means 54, with reference to a calling party telephone number which is included in response notification of the exchange 2. An operator of the extension telephone 3c, which also belongs to the call reception group 2, started a talk with the customer A, and thereby, it is turned into such a status that there is no extension telephones 3c˜3f, which are available to receive a call, in the call reception group 2.

There, it is assumed that a call from a customer B, which is a new call, reached to the exchange 2 (S108).

The call status notification means 22 of the exchange 2 notifies reception of the call from the customer B, to the CCS server 5, as incoming call generation notification (S109).

The extension line control means 52 of the CCS server 5 searches an call reception group to the call from the customer B, from the call reception group setup means 58. In case that the call from the customer B is addressed to the call reception group 2, the extension line control means 52 searches whether there is no extension telephone 3 which is available to receive a call, in the call reception group 2, from an extension line status of the extension line management means 51, but in case that the extension telephone 3c which also belongs to the call reception group 2 and is talking with the customer B, and the extension telephones 3d, 3e, 3f, which belong to the call reception group, are in a talk status, there is no extension telephone 3 which is available to receive a call (S110).

Therefore, the extension line control means 52 notifies to the exchange 2 so as to turn the call from the customer B into a distribution waiting status. The call control means 23 of the exchange 2, which received the notification, turns the call from the customer B into a distribution waiting status, and transmits a message which draws on waiting for a talk (OGM: OutGoing Message) or a ring back tone, to the customer B (S111).

By the extension line control means 52, a calling party telephone number of the customer B, which is information of the call from the customer B, is stored in the storage means 53 as distribution waiting information. In this case, it is stored in waiting queue of the call reception group 2 of the storage means 53 (S112).

Content of the storage means 53 is displayed by the display means 54.

A display example of the CCS server 5 at this time will be described on the basis of FIG. 6. As shown in FIG. 6, in a call management area of a window which is displayed on the display means 54, a calling party telephone number of the customer A is displayed on “Chris” of the operator 3, and she is talking with the customer A. In addition, a calling party telephone number of the customer B, which shows the call from the customer B, is displayed on waiting queue of “Tech Support” in the call reception group 2, and thereby, it shows that there was incoming of the call from the customer B but there is no extension telephone 3 which is in a waiting status wherein a call can be received, in extension lines which belong to the call reception group 2, and the call from the customer B is in a distribution waiting status. This is because the extension line control means 52 refers to a calling party telephone number which is included in response notification of the exchange 2 and displays it on the display means 54, and refers to a calling party telephone number which is included in distribution waited call information of the customer B, stored in waiting queue of the call reception group 2 of the storage means 53, and displays it.

When an operator of the CCS server 5 judges that call reception at the extension telephone 3c is optimum, for such reasons that there was a talk with an operator of the extension telephone 3c previously, by a calling party telephone number of the customer B or information from the calling party information storage means, or an operator of the extension telephone 3c is optimum to a technical level of the customer B, and so on, the call from the customer B and an extension number of the extension telephone 3c, which are distributed waited information, are selected by the selection means 55 of the CCS server 5.

Then, by the call reservation means 56, the call from the customer B is associated with the extension telephone 3c and stored in the storage means 53, and thereby, a call reservation is carried out (S113).

A display example of the CCS server 5 at this time will be described on the basis of FIG. 7. As shown in FIG. 7, in a call management area of a window which is displayed on the display means 54, a calling party telephone number of the customer A is displayed on “Chris” of the operator 3, and she is talking with the customer A. In addition, a calling party telephone number of the customer B, which shows the call from the customer B, is displayed on waiting queue of “Tech Support” in the call reception group 2, and “R” is added to this calling party telephone number of the customer B, and thereby, it shows that a call reservation was completed in such a manner that the call from the customer B reaches to the operator 3. This is because the extension line control means 52 refers to a calling party telephone number which is included in response notification of the exchange 2 and displays it on the display means 54, and carries out such display that “R” is added to a calling party telephone number, in accordance with content of talk reserved call information. of the customer B, which was stored in waiting queue of the call reception group 2 of the storage means 53. In this manner, it is configured so as to be able to easily discriminate that a call reservation was completed, by adding “R” to a calling party telephone number of a customer. It is desirable that display of a call reservation is displayed distinctly, such as reversing display of a calling party telephone number and flashing of characters, other than “R”.

In case that a distribution waited call of the customer B was not reserved for a talk, at such a time point that the extension telephones 3c˜3f of the call reception group 2 were turned into a waiting state in which a call can be received, the extension line control means 52 controls the distribution waited call of the customer B in such a manner that is reaches to the extension telephones 3c˜3f However, by the selection means 55 and the call reservation means 56, a call reservation was carried out in such a manner that the distribution waited call of the customer B reaches to the extension telephone 3c, and therefore, even when the extension telephones 3d˜3f were turned into a waiting status in which a call can be received, the extension line control means 52 does not carry out control of call reception to the extension telephones 3d˜3f.

In addition, in case that the customer B was addressed to the same call reception group 1, in this embodiment 1, a call is to always reach to a small (young) extension number which is available to receive a call, and therefore, in case that the extension telephone 3a or 3b became available to receive a call, the distribution waited call of the customer B is controlled by the extension line control means 52 so as to be received by the extension telephone 3a or 3b. However, in the same manner, a call reservation was carried out by the call reservation means 56, in such a manner that the distribution waited call of the customer B reaches to the extension telephone 3c, and therefore, even when the extension telephone 3a or the extension telephone 3b was turned into a waiting status in which a call can be received, the extension line control means 52 does not carry out control of call reception to the extension telephone 3a or the extension telephone 3b.

An operator of the extension telephone 3c completes a talk with the customer A, and cuts off the talk by use of the extension telephone 3c (S114).

The call status notification means 22 of the exchange 2 notifies cutoff of the call from the customer A and the extension telephone 3c, to the CCS server 5, as cutoff notification (S115).

A display example of the CCS server 5 at this time will be described on the basis of FIG. 8. As shown in FIG. 8, in a call management area of a window which is displayed on the display means 54, “Chris”, who is the operator 3, completed a talk with the customer A, and therefore, display of a calling party telephone number of the customer A is deleted. Then, on waiting queue of “Tech Support” which is in the call reception group 2, a calling party telephone number of the call from the customer B is displayed, and it shows that it is still in a distribution waiting status. This is because the extension line control means 52 displays an extension line status of the extension telephone 3c of the extension line management means 51 on the display means 54, and displays a calling party telephone number which is included in talk reserved call information of the customer B, stored in waiting queue of the call reception group 2 of the storage means 53.

The extension line management means 51 of the CCS server 5, which received cutoff notification, turns an extension line status of the extension telephone 3c into a waiting status, for the reason that the extension telephone 3c became available to receive a call. When the extension line control means 52 judges that the extension telephone 3c, which is a call reservation destination of the distribution waited call of the customer B which was reserved, became available to receive a call, from an extension line status (waiting status) of the extension line management means 51 and content of the storage means 53, it notifies to the call control means 23 of the exchange 2 so as to release distribution waiting of the call from the customer B, and to have the extension telephone 3c received the call (S116).

The call control means 23 of the exchange 2, to which the release of distribution waiting was notified, notifies to the talk channel switch 21 so as to have the extension telephone 3c received the call from the customer B which was turned into a distribution waiting status, and sounds the extension telephone 3c. The extension line management means 51 of the CCS server 5, which received the notification, turns an extension line status of the extension telephone 3c into a talk status in which a call reception is not possible (S117).

An operator, who is in charge of the extension telephone 3c, starts a talk with the customer B (S118).

The call information notification means 22 of the exchange 2 notifies response notification, which shows that the extension telephone 3c responded to a call, to the CCS server 5 (S119).

A display example of the CCS server 5 at this time will be described on the basis of FIG. 9. As shown in FIG. 9, an extension line management area of a window, which is displayed on the display means 54, is showing that, for such a reason that the extension telephone 3c of “Chris”, who is the operator 3, was turned into a waiting status in which a call can be received, the call from the customer B, which was stored in waiting queue of “Tech Support” which is in the call reception group 2, was made to reach to “Chris” which was the call reserved operator 3, by displaying a calling party telephone number of the customer B to the operator 3. In this case, “Chris”, who is the operator 3, belongs to both of the call reception group 1 and the call reception group 2, and the call from the customer B is addressed to the call reception group 2, and therefore, it is displayed as call reception under “Tech Support” which is in the call reception group 2. Then, since a distribution waited call disappeared in the waiting queue of the call reception group, display is eliminated. The extension line control means 52 displays an extension line status of the extension telephone 3c of the extension line management means 51 on the display means 54.

In this manner, the call center system, which relates to the embodiment 1 of the invention, manages a call as waiting queue in the storage means, in case that there is no extension telephone which is not available to receive a call, to a call from an external line, and selects a call which was desired to talk, and an extension telephone by which a call was desired to be received, out of the waiting queue, and makes a connection of them to make a call reservation, and thereby, it is possible to realize a call center system with high convenience and efficiency.

As above, the call center system, which relates to the embodiment 1 of the invention, was described, but the invention is not limited to the above-described embodiment, and a call reservation by the CCS server, which is a call center server, enables an extension telephone, which belongs to any call reception group, to receive a call. For example, even when a call from an external line was addressed to the call reception group 2, a call reservation destination can be set up to an call reception group other than the call reception group 2.

(Embodiment 2)

A call center system of an embodiment 2 of the invention will be described on the basis of FIG. 2 and FIG. 11 through FIG. 20. FIG. 11 is a view showing a configuration of the call center system of the embodiment 2. FIG. 12 is a view showing a configuration of a CCS server in the embodiment 2. FIG. 13 is a view showing a configuration of an operator terminal in the embodiment 2. FIG. 14 is a view showing an operation of the call center system of the embodiment 2. FIG. 15 through FIG. 19 are views which show display examples of the CCS server and the operator terminal in the embodiment 2 of the invention. FIG. 20 is a view showing a display example of another operator terminal side which is not reserved for call.

In the embodiment 1, a call reservation was carried out by the CCS server, but in the call center system of the embodiment 2, it was configured so as to enable a call reservation from an operator terminal which each operator operates. In a call center system 30 of the embodiment 2 shown in FIG. 11 through FIG. 13, the same reference numerals and signs are applied to the same configuration as that in the embodiment 1, and overlapped explanations will be omitted.

As shown in FIG. 11 and FIG. 12, a CCS server 60, which is a call center server, is equipped with call status relay means 61 which notifies call reception notification and cutoff notification of a call which is notified from call information notification means 22 of an exchange 2, etc. to operator terminals 32, queue information notification means 62 which notifies a call from an external line which can not be received by an extension telephone, to the operator terminal 32 (32a˜32f), and call reservation reception means 63 which receives a call reservation destination selected by the operator terminal 32 and notifies it to call reservation means 56.

In addition, the call reservation means 56 of the CCS server 60 stores as talk reserved call information in storage means 53, by notification of a call reservation destination from the operator terminal 32, which the call reservation reception means 63 received. As shown in FIG. 13, the operator terminal 32 is equipped with distribution waited call reception means 33, selection means 34, call reservation notification means 35, and display means 36. The distribution waited call reception means 33 is reception means which receives information of reception waited calls from an external line (distribution waited call) to the extension telephone 3, which was notified from queue information notification means 62 of the CCS server 60.

The selection means 34 has a function of selecting one or more reception waited calls from an external line to extension telephone, and of selecting a call reception destination of the selected call from an external line, from the extension telephones 3a˜3f, to set up it as a call reservation destination. The selection means 34 displays content of the distribution waited call reception means 33 on the display means 36, and selects a call from an external line, which is in a distribution waiting status since a call can not be received by the extension telephone 3, and the extension telephones 3a˜3f by which a call is desired to be received, through the use of input means such as a mouse and a keyboard which are not shown in the figure.

The call reservation notification means 35 has a function of associating distribution waited call information, which is information of a call from an external line, which can not be received, with an extension telephone as a call reservation destination, and of notifying it as talk reserved call information to the call center server.

An operation of the call center system 30 of the embodiment 2, which was configured in this manner, will be described on the basis of FIG. 14. As shown in FIG. 14, firstly, a call from a customer A reached to the exchange 2 (S201).

The call status notification means 22 of the exchange 2 transmits incoming call generation notification of the call from the customer A, to the CCS server 60 (S202).

When the extension line control means 52 of the CCS server 60 receives the incoming call generation notification from the exchange 2, it refers to a call reception group to the call from the customer A, an extension line 9 which belongs to that call reception group, and a talk status of the extension telephone 3 which is connected to that extension line 9, from content of the call reception group setup means 58 and an extension line status of the extension line management means 51, and searches the extension telephone 3 which is available to receive a call. In this case, the call from the customer A is a call reception to a call reception group 1, and an extension telephone, which is available to receive a call at that time, is set to the extension telephone 3c (S203).

In S203, when the extension line control means 52 judges that an extension line, which is available to receive a call in the call reception group 1, is the extension telephone 3c, it notifies an extension number of the extension telephone 3c as call reception request notification, to the exchange 2, so as for the extension telephone 3c to receive the call from the customer A (S204).

When the call control means 23 of the exchange 2 received such call reception request notification that the call from the customer A is made to be received by the extension telephone 3c, from the CCS server 60, it notifies to the talk channel switch 21 and has the call reached to the extension telephone 3c and sounds it (S205).

The call status notification means 22 of the exchange 2 transmits such call reception notification that the call from the customer A was received by the extension telephone 3c, to the CCS server 60 (S206).

The extension line management means 51 of the CCS server 60, which received the notification, turns a status of the extension telephone 3c into a talk status in which call reception is impossible. In addition, the call status relay means 61 of the CCS server 60 notifies incoming call generation notification of the call from the customer A to the operator terminals 32a˜32f in S202. This is because an extension line status of the common extension telephone 2 is managed in all operator terminals 32 and the CCS server 31, by transmitting call reception notification and cutoff notification of respective extension telephones, to all operator terminals 32 (S207).

When an operator, who is in charge of the extension telephone 3c, hooks up the extension telephone 3c, and starts a talk with the customer A, the call status notification means 22 of the exchange 2 notifies that the call from the customer A started to talk with the extension telephone 3c, as response notification, to the CCS server 60 (S208).

The call status relay means 61 of the CCS server 60 has the call from the customer A, which was received in S208, reached to the extension telephone 3c, and notifies such notification that it was responded by the extension telephone 3c, to the operator terminals 32a˜32f (S209).

In S209, display examples of the CCS server 60 and the operator terminal 32 will be described on the basis of FIG. 15. As shown in FIG. 15(a), on a screen of the display means 54 of the CCS server 60, extension line statuses of respective extension telephones 3, and content of waiting queue of the storage means 53 are displayed in a window having a call management area hierarchized in such a manner that an upper layer was set up as an call reception group and a lower layer was set up to operators who belong to that call reception group.

A calling party telephone number of the customer A is displayed on “Chris” who is an operator 3 belonging to “Sales” which is in the incoming group 1 of the call management area, and thereby, it shows that she is talking with the call from the customer A. The extension line control means 52 displays this on the display means 54, with reference to a calling party telephone number which is included in response notification of the exchange 2.

As shown in FIG. 15(b), on a screen of the display means 36 of the operator terminal 32c at that time, displayed is a window having a call status display area which shows a extension line status of the extension telephone 3c which makes a pair with the operator terminal 32c. This is such a thing that the display means 36 of the operator terminal 32 displays an extension line status of the extension telephone 3 in a call status display area of this window, from incoming call generation notification, call reception notification, response notification and cutoff notification, which are notified from the CCS server 60, and calling party telephone numbers of customers, which are included in respective notifications.

In FIG. 15(b), a calling party telephone number of the customer A is displayed in the call status display area, and “Talking”, which shows that the call is in a talk status, is displayed, and thereby, it shows that the extension telephone 3c and the customer A are in a talk status. Since the customer A and the operator 3 of the extension telephone 3c started talking, there occurs such a status that there is no extension telephone 3 which is available to receive a call, in the call reception group 1.

There, it is assumed that a call from a customer B, which is a new call, reached to the exchange 2 (S210).

The call status notification means 22 of the exchange 2 notifies call reception notification of the call from the customer B, to the CCS server 60. (S211).

The extension line control means 52 of the CCS server 60 searches an call reception group to the call from the customer B, from the call reception group setup means 58. In case that the call from the customer B is addressed to the call reception group 2, the extension line control means 52 searches whether there is no extension which is available to receive a call, in the call reception group 2, from an extension line status of the extension line management means 51, but the extension telephone 3c, which also belongs to the call reception group 2 and is talking with the customer B, was turned into a talk status, and thereby, it is recognized that there is no extension line which is available to receive a call (S212).

Therefore, the extension line control means 52 notifies to the exchange 2 so as to turn the call from the customer B into a distribution waiting status. The call control means 23 of the exchange 2, which received the notification, turns the call from the customer B into a distribution waiting status, and transmits OGM which draws on waiting form a talk, to the customer B through the talk channel switch 21 (S213).

By the extension line control means 52, a calling party telephone number of the customer B, which is information of the call from the customer B, is stored in waiting queue of the call reception group 2 of the storage means 53 (S214).

Then, the queue information notification means 62 notifies distribution waited call information of the customer B, which was stored in waiting queue of the call reception group 2 of the storage means 53, to the operator terminals 32a˜32f (S215).

The distribution waited call reception means 33 of the operator terminal 32 notifies content of the received distribution waited call information to the selection means 34. Then, by the selection means 34, it is displayed on the display means 36. An operator 3, which operates the operator terminal 32c, takes a look at the distribution waited call information displayed on the display means 36, over talking with the customer A, and confirms a distribution waited call from the customer B to the call reception group 2.

Display examples of the CCS server 60 and the operator terminal 32 at this time will be described on the basis of FIG. 16. As shown in FIG. 16(a), in a call management area of a window which is displayed on the display means 54, “Chris”, who is the operator 3, is talking with the customer A. Then, on waiting queue of “Tech Support” which is in the call reception group 2, a calling party telephone number of the call from the customer B is displayed, and thereby, it shows that there is reception of the call from the customer B, and there is no extension telephone 3 in a waiting status in which a call can be received, in extension lines which belong to the call reception group 2, and the call from the customer B is in a distribution waiting status. This is because the extension line control means 52 displays on the display means 54, with reference to a calling party telephone number which is included in response notification of the exchange 2, and displays content of distribution waited call information of the customer B, which was stored in waiting queue of the call reception group 2 of the storage means 53.

As shown in FIG. 16(b), in a window of the display means 36 of the operator terminal 32c at that time, displayed are an extension line status display area which shows an extension line status of the extension telephone 3c which makes a pair with the operator terminal 32c, a waiting queue display area which displays content of waiting queue stored in the storage means 53 of the CCS server 60. In the extension line status display area, displayed is a calling party telephone number of the customer A, and “Talking”, which shows a talk status, is displayed, and thereby, it shows that the operator 3 continues talking with the customer A at the extension telephone 3c. In addition, the waiting queue display area is displayed by the display means 36 on the basis of a calling party telephone number etc. which are included in distribution waited call information notified from the CCS server 60 and received by the distribution waited call reception means 33. FIG. 16(b) shows that the call from the customer B, which became a distribution waited call since there is no extension telephone which is available to receive a call, is stored in waiting queue of the call reception group 2. The operator 3 judges whether a call reservation is carried out or not, depending on content of this waiting queue.

In addition, a display example of a window, which is displayed by display means 36 of another operator, e.g., of the operator terminal 32a, will be shown in FIG. 20(a). In a call status display area, displayed is a calling party telephone number of another customer whom an operator 1 is talking with, and it shows that the operator 1 is talking by use of the extension telephone 3a. Then, in a waiting queue display area, displayed is such a status that a calling party telephone number of the customer B was stored in waiting queue of the call reception group 2, which is the same display content as that of the waiting queue display area of FIG. 16(b).

In sum, it is possible to refer to content of waiting queue in common from respective operator terminals 32, and therefore, it is possible to easily refer to a call which was reserved for a talk. In addition, on this screen, a call from the customer B, which is a distribution waited call, and one extension telephone 3 out of a plurality of extension telephones 3, are selected by the selection means 34 of the operator terminal 32a and the call reservation notification means 35, and the selected extension telephone 3 is associated with the call from the customer B to be set up as talk reserved call information, and thereby, it is also possible to make a call reservation to the extension telephone 3 which oneself or another operator uses.

In case that the operator 3 desired to take the call from the customer B, which is a distribution waited call, by oneself, the call from the customer B is selected by the selection means 34, through the use of input means such as a mouse. The selected distribution waited call is associated with the extension telephone 3c in distribution waited call information of the customer B by the call reservation notification means 35, and it is notified to the CCS server 60 as talk reserved call information (S216).

The call reservation reception means 63 of the CCS server 60, which received notification of talk reserved call information from the operator terminal 32c, makes a connection of distribution waited call information of the customer B with the extension telephone 3c and stores it in the storage means 53 (S217).

Display examples of the CCS server 60 and the operator terminal 32 at this time will be described on the basis of FIG. 17. As shown in FIG. 17(a), in a call management area of the display means 54, “Christ” of the operator 3 is talking with the customer A. Then, a calling party telephone number of the customer B, which shows the call from the customer B, is displayed on waiting queue of “Tech Support” in the call reception group 2, and “R” is added to this calling party telephone number of the customer B, and thereby, it shows that a call reservation was completed in such a manner that the call from the customer B reaches to the operator 3. This is because the extension line control means 52 refers to a calling party telephone number which is included in response notification of the exchange 2 and displays it on the display means 54, and carries out such display that “R” is added to a calling party telephone number, in accordance with content of talk reserved call information of the customer B, which was stored in waiting queue of the call reception group 2 of the storage means 53. In this manner, it is configured so as to be able to easily discriminate that a call reservation was completed, by adding “R” to a calling party telephone number of a customer.

As shown in FIG. 17(b), in a window of the display means 36 of the operator terminal 32c at that time, a calling party telephone number of the customer A is displayed in an extension line status display area, and “Talking” is displayed, and thereby, it shows that the operator 3 continues talking with the customer A at the extension telephone 3c. In addition, in a waiting queue display area, displayed is a call from the customer B with “R” added to a calling party telephone number which shows that the call from the customer B is selected by input means such as a mouse and was reserved for a talk. A calling party telephone number of the customer A, which is displayed in a waiting queue display area and is distribution waited call information, is clicked by a mouse which is one example of the selection means 34, and thereby, a call reservation is carried out, and thereby, “R” is added to a calling party telephone number of the customer B, and information of the call from the customer B is associated with the extension telephone 3c which is a call reservation destination, and it is notified to the CCS server 60.

In addition, a display example of a window, which is displayed by the display means 36 of the operator terminal 32a of another operator at this time, is shown in FIG. 20(b). As shown in FIG. 20(b), “R”, which shows that the call from the customer B, which was reserved for a talk by the operator terminal 32c, was stored in the call reception group 2 of waiting queue in the waiting queue display area, is added to the call, and confirmation is also taken from the operator terminal 32a. In this manner, it is possible to refer to waiting queue from respective operator terminals 32, and therefore, it is possible to prevent double call reservations.

It is also possible to release a talk reservation of the call of the customer B, shown in FIG. 17(b). Call reservation release is carried out by selecting a calling party telephone number of the customer B which was reserved for a talk in the waiting queue display area and to which “R” was added, with a right click of a mouse etc. of the selection means 34, and thereby, release of a call reservation of the extension telephone 3c, which was associated with the customer B from the call reservation notification means 35, is notified to the CCS server 60. Then, the call reservation means 56 of the CCS server 60 removes information of the extension telephone 3c associated with talk reserved call information of the call of the customer B from waiting queue of the storage means 53, and thereby, a call reservation is released.

In case that a distribution waited call of the customer B was not reserved for a talk, in the same manner as in the embodiment 1, at such a time point that the extension telephones 3c˜3f of the call reception group 2 were turned into a waiting state in which a call can be received, the extension line control means 52 controls the call from the customer B in such a manner that is reaches to the extension telephones 3c˜3f. However, by the operator terminal 3c, a call reservation was carried out in such a manner that the distribution waited call of the customer B reaches to the extension telephone 3c, and therefore, even when the extension telephones 3d˜3f were turned into a waiting status in which a call can be received, the extension line control means 52 does not carry out control of call reception to the extension telephones 3d˜3f.

An operator of the extension telephone 3c completes a talk with the customer A, and cuts off a talk by use of the extension telephone 3c (S218).

The call status notification means 22 of the exchange 2 detects cutoff between the call from the customer A and the extension telephone 3c, and notifies the cutoff notification to the CCS server 60 (S219).

The call information relay means 61 of the CCS server 60 notifies cutoff of the call from the customer A in S210, to the operator terminals 32a˜32f (S220).

Display examples of the CCS server 60 and the operator terminal 32c at this time will be described on the basis of FIG. 18. As shown in FIG. 18(a), in a call management area of a window which is displayed on the display means 54, “Chris”, who is the operator 3, completed a talk with the customer A, and therefore, display of a calling party telephone number of the customer A is deleted. Then, in waiting queue of “Tech Support” in the reception call group 2, a calling party telephone number of the call from the customer B is displayed, and it shows that it is still in a distribution waiting status. This is because the extension line control means 52 displays an extension line status of the extension telephone 3c of the extension line management means 51 on the display means 54, and displays content of talk reserved call information of the customer B which was stored in waiting queue of the call reception group 2 of the storage means 53.

As shown in FIG. 18(b), in the operator terminal 32c at that time, a calling party telephone number of the customer A, which was displayed in the call status display area, is deleted due to cutoff notification between the extension telephone 3c and the customer A, which is notified from the CCS server 60, and the talk reserved call from the customer B, which is displayed in the waiting queue display area, is continuously displayed in the waiting queue display area of the call reception group 2, since it is in a distribution waiting status in which call reception notification from the CCS server 60 is not received.

The extension line management means 51 of the CCS server 60 changes a status of the extension telephone 3c to a waiting status, since a talk of the extension telephone 3c is cut off and the extension telephone 3c becomes available to receive a call. The extension line control means 52 notifies call reception request notification to the exchange 2 so as to distribute a distribution waited call to the extension telephone 3c, when it judges that the extension telephone 3c, which is a call reservation destination of the talk reserved call from the customer B, became available to receive a call, from an extension line status (waiting status) from the extension line management means 51, and waiting queue of the storage means 54 (S221).

The call control means 23 of the exchange 2, to which distribution of a distribution waited call was notified, notifies to the talk channel switch 21 so as to have the call from the customer B, which was turned into a distribution waiting status, reached to the extension telephone 3c, and sounds it. In addition, the call status notification means 22 transmits call reception notification which is such notification that the call from the customer B was reached to the extension telephone 3c, to the CCS server 60 (S222).

The call status relay means 61 of the CCS server 60 notifies call reception notification from the exchange 2, to the operator terminals 32a˜32f (S223). The extension line management means of the CCS server 5, which received the notification, changes a status of the extension telephone 3c to a talk status in which a call can be received.

When the operator 3, who is in charge of the extension telephone 3c, hooks up it and starts a talk with the customer B, the call status notification means 22 of the exchange 2 notifies such response notification that the extension telephone 3c responded to a call, to the CCS server 60 (S224).

The call status relay means 61 of the CCS server 60 relays such response notification that the extension telephone 3c responded to the received call from the customer B, to the operator terminals 32a˜32f (S225).

Display examples of the CCS server and the operator terminal 32c at this time will be described on the basis of FIG. 19. As shown in FIG. 19, an extension line management area of a window, which is displayed on the display means 54, shows that the call from the customer B, which was stored in waiting queue of “Tech Support”, which is in the call reception group 2, was made to reach to “Chris” who is the operator 3 reserved for a talk, by displaying a calling party telephone number of the customer B to the operator 3, since the extension telephone 3c of “Chris” who is the operator 3 was turned into a waiting status in which a call can be received. In this case, “Chris”, who is the operator 3, belongs to both of the call reception group 1 and the call reception group 2, and the call from the customer B is addressed to the call reception group 2, and therefore, it is displayed as a call reception under “Tech Support” which is in the call reception group 2. Then, since a distribution waited call disappeared in waiting queue of the call reception group 2, display has been deleted.

As shown in FIG. 19(b), on the operator terminal 32c at that time, a status of talking with the call from the customer B is displayed in a call status display area, by response notification from the CCS server 60 between the extension telephone 3c and the customer B. In addition, in a waiting queue display area, it is displayed that there is no call stored in waiting queue, since response notification of the call from this customer B was received from the CCS server 60.

In this manner, the call center system, which relates to the embodiment 2 of the invention, can make a call reservation easily as to a call which was received from a customer through each operator terminal and is turned into a distribution waiting status, and therefore, it is possible to realize a call center system with high convenience.

As above, the call center system, which relates to the embodiment 2 of the invention, was described, but the invention is not limited to the above-described embodiment, and setup means, which sets up a rank of each operator terminal, is disposed in the CCS server, and by imposing such a restriction that a call reservation from an operator terminal is permitted or is not permitted etc., depending on a rank of the operator terminal, it becomes possible to realize a call center system with much higher convenience.

(Embodiment 3)

A call center system of an embodiment 3 of the invention will be described on the basis of FIG. 2, FIG. 13 and FIG. 21 through FIG. 23. FIG. 21 is a view showing a configuration of the call center system in the embodiment 3. FIG. 22 is a view showing a configuration of a CSS server of the call center system in the embodiment 3. FIG. 23 is a view showing an operation of the call center system in the embodiment 3.

In the embodiment 3, in the CCS server which is a call center server, disposed is talk reserved call control means which manages elapsed time wherein a talk reserved call was turned into a distribution waiting status. In a call center system 40 of the embodiment 3 shown in FIG. 21 and FIG. 22, explanations of the same configuration as that of the embodiment 2 will be omitted by applying the same reference numerals and signs thereto. As shown in FIG. 21 and FIG. 22, a CCS server 70, which is used in the call center system 40 of the embodiment 3, is equipped with talk reserved call control means 71 which manages elapsed time of a talk reserved call. Meanwhile, the same reference numerals and signs are applied to the same configuration as those of the embodiment 1 and the embodiment 2, and overlapped explanations will be omitted.

In case that the talk reserved call control means 71 measures elapsed time from such a time point that a distribution waited call of a customer, which was turned into a distribution waiting status by the call reservation means 56 of the CCS server 70, was reserved for a talk and predetermined time or more passed over, a warning is notified to the operator terminal 32 which transmitted talk reserved call information. In addition, the talk reserved call control means 71 notified the warning, and thereafter, in case that a call does not received by an extension telephone which was desired to receive the call even when a given length of time passed over, it releases a talk reserved call which was stored in the storage means 53, and notifies to the extension control means 52 so as to have another extension telephone, which is available to receive a call, received the call.

An operation of the call center system of the embodiment 3, which is configured in this manner, will be described on the basis of FIG. 23. As described in the embodiment 2, S201 in which a call was received from the customer A through S217 in which a call reservation is notified from the operator terminal 32c to the CCS server 70 and a call, which was turned into a distribution waiting status by the call reservation means 56 of the CCS server 70, was reserved for a talk, are the same, and explanations will be omitted.

The talk reserved call control means 71 measures elapsed time of the call from the customer B, which was reserved for a talk by the operator terminal 32c. For example, time monitoring of approximately 3 minutes is carried out (S301). In case that the operator 3, who is in charge of the operator terminal 32c, does not cut off a talk with the customer A even when predetermined time passed over (S302), the talk reserved call control means 71 notifies a warning to the operator terminal 32c (S303).

The operator terminal 32c, which received the warning, applies display showing the warning, to a calling party telephone number which shows the call from the customer B in waiting queue which is displayed on the display means 36. The warning display can be carried out by applying reversing display to, flashing, and applying a striking color to, a calling party telephone number, and by popping up another warning window (S304).

The warning, which the talk reserved call control means 71 notifies, is configured so as to appear only on the operator terminal 32c which was reserved for a talk, since there is no need to particularly keep close watch on other operator terminals 32a, 32b, 32d˜32f which are not reserved for a talk. Therefore, it is possible to prevent occurrence of such a status that an operator has trouble concentrating, by carrying out no display of a needless warning.

In addition, it is all right even if a warning, which the talk reserved call control means 71 notifies, is addressed to all operator terminals 32a˜32f. By doing so, it is possible to sound a warning to all operators, and it is possible for an adjacent operator etc. to call attention to an operator who forgot that a call reservation was made regardless of such a fact that the call reservation was made. Then, in case that the operator 3 does not cut off a talk with the customer A, the talk reserved call control means 71 measures time from such a time point that a warning was notified to the operator terminal 32c. For example, time monitoring of approximately 3 minutes is carried out (S305).

In case that the operator 3, who is in charge of the operator terminal 32c, does not cut off a talk with the customer A successively even when predetermined time passed over (S306), the talk reserved call control means 71 notifies the talk reserved call from the customer B to the exchange 2 through the extension line control means 52, so as to have the extension telephone 3e received a call if the extension telephone 3 which is available to receive a call, e.g., the extension telephone 3e is in a waiting status in which a call can be received (S307). At the same time, it notifies such a fact that a call reservation of the call from the customer B was released to the operator terminals 32a˜32f through the call reservation means 56, and deletes information of the call from the customer B, from waiting queue of the storage means 53 (S308).

In this manner, in case that a talk reserved call can not be received even when predetermined time passed over, the talk reserved call control means notifies a warning to an operator terminal, and thereby, it is possible to prevent such a situation that an operator forgot that a call reservation was made. In addition, it is possible to trigger such an operator's effort that the operator completes a talk with a customer whom the operator is currently talking with. Thus, it is possible to realize a call reception and to draw on a connection with an operator, to a customer who is hang up without modification of a distribution waiting status, and it is possible to realize improvement of customer satisfaction level.

As above, the call center system of the embodiment 3 was explained, but the invention is not limited to the above-described embodiment, and by disposing means which sets up time for notifying a warning and time for distributing it to another extension telephone which is available to receive a call, with respect to each operator terminal, in the talk reserved call control means of the CCS server, it is possible to set up optimum monitoring time with respect to each operator terminal, and it is possible to realize a call center system with high convenience.

(Embodiment 4)

A call center system of an embodiment 4 of the invention will be described on the basis of FIG. 11 through FIG. 13, and FIG. 24. FIG. 24 is a view showing an operation of the call center system of the embodiment 4. In the embodiment 2, described was the example in which a distribution reserved call from an external line is made to be received by an extension telephone associated with an operator terminal which was reserved for a talk. In contrast to this, in the embodiment 4, it is configured to realize a call center system which makes a call reservation so as to have another extension telephone received a call.

The call center system of the embodiment 4 is identical to the configuration of FIG. 11 in the embodiment 2, and therefore, explanations will be omitted by using the same reference numerals and signs.

As shown in FIG. 24, an operator 3 is talking with a customer A by an extension telephone 3c which belongs to a call reception group 1 (S401). At that time, in case that a call from a customer B, which is addressed to the call reception group 1, was received by an exchange 2 (S402), the exchange 2 notifies incoming call generation of the call from the customer B (S403).

In case that there are no extension telephones 3a˜3d which are available to receive a call in the call reception group 1, a CCS server 60 stores a calling party telephone number of the call from the customer B in storage means 53, and notifies to the exchange 3 so as to turn the call from the customer B into a distribution waiting status (S404).

Then, the CCS server 60 notifies that the call was stored as a distribution waited call of the customer B in waiting queue of the call reception group 1 of the storage mean 53, to operator terminals 32a˜32f. In FIG. 24, only the operator terminal 32a and the operator terminal 32c are shown in the figure (S405).

By the operator terminal 32a which an operator 1 uses, a call reservation is made so as to have the extension telephone 3c, which the operator 3 uses, received the distribution waited call of the customer B, which was stored in the waiting queue, and it is notified to the CCS server 60 (S406).

The operator 3 of the extension telephone 3c completes a talk with the customer A, and cuts off the talk by the extension telephone 3c (S407).

The exchange 2 detects cutoff between the call from the customer A and the extension telephone 3c, and notifies cutoff of the call from the customer A to the CCS server 60 (S408).

Call status relay means 61 of the CCS server 60 notifies cutoff of the call from the customer A in S408, to the operator terminal 32c (S409).

The CCS server 60 notifies to the exchange 2 so as to release distribution waiting, when it judges that the extension telephone 3c, which is a reservation destination of a distribution waited call of the customer B which was reserved for a talk, became available to receive the call, from waiting queue of the storage means 53, judging from such a fact that a call of the extension telephone 3c was cut off and the extension telephone 3c became available to receive a call (S410).

The exchange 2, to which distribution waiting release was notified, has the distribution waited call from the customer B reached to the extension telephone 3c and sounds it, and thereby, the operator 3 starts talking with the customer B by use of the extension telephone 3c (S411).

As above, the call center system of the embodiment 4 of the invention was described, but the invention is not limited to the above-described embodiment, and setup means, which sets up a rank of each operator terminal, is disposed in the CCS server, and, in case that a call reservation was made, ranks of operator terminals are compared with each other, and, by carrying out such control that a call reservation from a low rank operator terminal to a high rank operator terminal is permitted or is not permitted etc., it becomes possible to realize a call center system with much higher convenience. In addition, it is also possible to restrict a call reservation to a different call reception group.

Meanwhile, in the explanation of the call center system of the embodiments 1 through 4 of the invention, the exchange and the call center server were explained as different ones, but it is all right even if the exchange and the call center server are accommodated in one unit of a housing. In sum, it is all right even if a call center system in which a call center server was omitted is realized, by using an exchange which has a function of a call center server, and it is also all right even if a call center system in which the exchange was omitted, by using a call center server which has a function of an exchange.

In addition, the exchange and the extension telephone were explained as different ones, but it is all right even if a call center system in which an operator terminal was omitted is realized by having a function of an operator terminal included in an extension telephone which had display means such as a liquid crystal display. In addition, a personal computer is used as an operator terminals, and the personal computer is equipped with a telephone function, and thereby, it is also possible to realize a call center system in which an extension telephone was omitted. Meanwhile, also as to a personal computer which was equipped with a telephone function (CTI telephone), similar content is described in open information (2002-0028353 US. Publication No.) as described above, and therefore, explanations will be omitted by quoting an open document.

(Embodiment 5)

A call center system of an embodiment of the invention will be described on the basis of FIG. 25 through FIG. 43. FIG. 25 is a block diagram of the call center system of the embodiment of the invention. FIG. 26 is a block diagram of an exchange in FIG. 25. FIG. 27 is a block diagram of a CCS server in FIG. 25. FIG. 28 is a block diagram of an operator terminal in FIG. 25. FIG. 29 and FIG. 30 are views which explain an operation of the call center system in FIG. 25. FIG. 31 and FIG. 32 are views which explain an operation of queue. FIG. 33 is a view showing one example of setup content of call reception group setup means. FIG. 34 through FIG. 36 are views which show display examples of the operator terminal and the CCS server. FIG. 37 is a view showing a display example of a call log which is displayed on the operator terminal. FIG. 38 is a view showing a display example of “a call reservation window” which is displayed on the operator terminal. FIG. 39 through FIG. 42 are views which show display examples of the operator terminal and the CCS server. FIG. 43 is a view showing a display example on the occasion of making a call reservation during a period of a call which is displayed on the operator terminal.

Firstly, a configuration of the call center system of the embodiment of the invention will be described on the basis of FIG. 25 through FIG. 28 and FIG. 33. As shown in FIG. 25, a call center system 101 has an exchange 102, a plurality of extension telephones 103 (103a˜103f) which were allocated to respective operators, operator terminals 104 (104a˜104f) which are allocated as pairs with respective extension telephones 103, and a CCS server 105 which carries out control of the exchange 102 and control of the operator terminals 104 and which is a call center server.

In case that a call request of a customer telephone 106 was received from an external line 108 through a general public line 107 such as a subscriber telephone network and ISDN (Integrated Service Digital Network), the exchange 102 distributes it to the extension telephones 103 connected to extension lines 109. In addition, the exchange 102 is connected to the operator terminals 104 and the CSS server 105 by a network 110 through a hub 111 which is a line concentrator. In addition, in case that the exchange 102 or the CCS server 105 is installed on a floor or in a building which is different from a room in which the operator terminal 104 was installed, communication is possible by connecting to it through a network relay device etc. such as a router.

The exchange 102 is connected to the CCS server 105 through a control line 112. As the control line 112, a general-purpose interface can be used. For example, it is possible to use LAN (Local Area Network) such as USB (Universal Serial Bus) and 100 Base-T, RS-232C by which bi-directional serial communication is possible, a bi-directional parallel interface etc. In addition, as a procedure of distributing information, it is possible to communicate by a procedure which conformed to CSTA (Computer Supported Telecommunication Applications) and a procedure of a specific protocol. The exchange 102 and the CCS server 105 carry out communication by the control line 112, but in case of carrying out communication through the use of the network 110, it is possible to omit the control line 112.

The extension telephones 103 are extension telephones 103a˜103d which are connected to extension lines belonging to a call reception group 1, and extension telephones 103c˜103f which are connected to extension lines belonging to a call reception group 2, and the CCS server 105 is set up in such a manner that the extension telephone 103c, 103d belong to both of the call reception groups 1 and 2.

Next, a configuration of the exchange 102 in the call center system of this embodiment will be described in detail on the basis of FIG. 26. As shown in FIG. 26, the exchange 102 has a talk channel switch 121, call status notification means 122, and call control means 123. The talk channel switch 121 forms a talk channel by changing over a switch which connects a talk channel between the external line 108 and the extension line 109, and the changeover is carried out by notification of the call control means 123.

In case that a call status of the talk channel switch 121 was changed, the call status notification means 122 notifies the status to the CCS server 105. For example, call reception notification when a call reaches to the exchange 102 from the external line 108, response notification when the extension telephone 103, to which a call reached from the exchange 102, responds, and cutoff notification when the extension telephone 103, which is connected through the exchange 102, cuts off a call from an external line by on-hook, are notified to the CCS server 105. In addition, the call status notification means 122 has a function of detecting reception of a call to the extension telephone 103 from the exchange 102 and cutoff of a call and of notifying it to the CCS server 105.

The call control means 123 carries out such control that a call of the external line 108 is turned into a call reception waiting status (distribution waiting) to any one of the extension telephones 103, and the call is received by the extension telephone which was designated from the CCS server 105, by notifying to the talk channel switch 121.

-CCS Server 105-

Next, a configuration of the CCS server 105 in the call center system of the embodiment of the invention will be described on the basis of FIG. 27. As shown in FIG. 27, the CCS server 105 has extension line management means 151, extension line control means 152, queue 153, call reservation control means 154, storage means 155, call log accumulation means 156, notification means 157, call reception group setup means 158, and display means 159.

The extension line management means 151 manages each status of a waiting status in which a call can be received and a talking status in which a call can not be received, as an extension line status, from content of call reception notification, response notification or cutoff notification from the exchange 102. In case that there was call reception notification or response notification to the extension telephone 103 in a waiting status in which a call can be received, an extension line status of this extension telephone 103 is turned into a talking status in which a call can not be received. In addition, in case that there was cutoff notification of the extension telephone 103 which is in a talking status, from the exchange 102, the extension line status is turned into a waiting status in which a call can be received.

In addition, the extension line management means 151 manages the extension telephones 103 and the operator terminals 104 in association with each other. For example, the extension telephone 103a and the operator terminal 104a which the same operator uses, the extension telephone 103b and the operator terminal 104b, the extension telephone 103c and the operator terminal 104c, the extension telephone 103d and the operator terminal 104d, etc. are associated with each other. This association is carried out by the extension line management means 151 making a connection of operator names which were inputted and IP addresses of the operator terminals 104, 1) by the extension line management means 151 making a connection of operator names and extension line numbers of extension telephones in advance, through the use of input means which is not shown in the figure, and 2) by inputting operator names from the operator terminals 104 to access (log in) to the CCS server 105.

The extension line control means 152 judges and determines the extension telephone 103 of a call reception destination to call reception notification from the exchange 102, and in case that the judged and determined extension telephone 103 of a call reception destination is available to receive a call due to the extension line status of the extension line management means 151, it notifies to call control means 123 of the exchange 102 so as to allow the extension telephone 103 of a call reception destination to receive a call, and in case that a call can not be received, it notifies to the call control means 123 of the exchange 102 so as to turn a call into a distribution waiting status.

For example, a call reception group and the extension telephone 103 which belongs to the call reception group are judged and determined, with reference to call reception group setup means 158, from call reception notification which is notified from the exchange 102. As a result of that, in case that a call from the external line 108 is addressed to the extension telephone 103a, the extension line control means 152 refers to an extension line status of the extension telephone 103a of the extension line management means 151. Then, if the extension line status of the extension telephone 103a is in a talk status, a call can not be received, and therefore, it is notified to the call control means 123 of the exchange 102 so as to turn into a distribution waiting status. On one hand, if the extension line status of the extension line 103a is in a waiting status, it is notified to the call control means 123 of the exchange 102 so as to have a received call reached to the extension telephone 103a.

In addition, the extension line control means 152 has a function as call reception request means which notifies to the exchange 102 so as to have the extension telephone 103, which was associated as a call reservation destination, received a call, in case that a call from the external line 108, which was associated with talk reserved call information which was notified from the operator terminal 104 and will be described later, was received by the exchange 102. Then, the extension line control means 152 manages a call from the external line 108 which can not be received by the extension telephone 103, as a distribution waited call, in the queue 153, and notifies to the exchange 102 so as to receive distribution reserved call in the order corresponding to call reception, every time the extension telephone 103 became available to receive a call. In addition, it is equipped with a function as distribution waited call management means which controls so as to set up the call from the external line 108 to a distribution waited call, in case that the call from the external line 108 can not be by the extension line 103 which is a call reservation destination associated with it by talk reserved call information, and so as to receive this distribution waited call in preference to other distribution waited calls, in case that the extension telephone 103 of a call reservation destination became available to receive a call.

The queue 153 is stored as a distribution waited call by the extension line control means 152, when a call from the external line 108 can not be received by the extension telephone 103 of a call reception destination. This distribution waited call is data which discriminates calls from the external line 108, and for example, it is possible to use calling party telephone numbers of calling parties, customer ID allocated with respect to each customer, identification ID allocated continuously in the order corresponding to call reception by the CCS server 105 on the occasion of call reception.

The call reservation control means 154 stores talk reserved call information which is notified by the operator terminals 104, in the storage means 155. In addition, the call reservation control means 154 has a function of monitoring such elapsed time that talk reserved call information was stored in the storage means 155, and of deleting the talk reserved call information from the storage means 155 to realse a call reservation, in case that a call from the external line 108, which was associated with talk reserved call information, is not received even when elapsed time passed over. The talk reserved call information is data which discriminates a talk reserved call from the external line 108, and for example, it is possible to use calling party telephone numbers of calling parties, customer ID, identification ID etc.

The call log accumulation means 156 accumulates a call log which is such a history that the extension telephone 103 talked. Meanwhile, in this call log, it is possible to include information during a period of talking. The notification means 157 has a function of informing the operators 104 which are paired with the extension telephones 103 which are reservation destinations of reception of a call from the external line 108 associated with talk reserved call information, when a call from the external line 108, which was associated with talk reserved call information stored in the queue 153, is received by the extension telephone 103 which is a call reservation destination.

The call reception group setup means 158 stores such a setup that telephone numbers of extension lines were grouped in accordance with calls from the external line 108. For example, they are made to correspond to, for example, a telephone number of the external line which a caller dialed (an external line where there was an incoming call) 108, a telephone number of a caller, extension numbers which were grouped in accordance with a plurality of call reception lines of the external line 108. FIG. 33 shows setup content of call reception groups which correspond to telephone numbers of external lines which certain caller dialed, as its one example.

As shown in FIG. 33, an external line “092-111-1111” corresponds to a call received by an call reception group 1, and therefore, the call is received by any one of extension numbers “11”˜“13” which were allocated to the extension telephones 103a through 103d. In addition, an external line “092-111-1112” corresponds to a call received by an call reception group 2, and therefore, the call is received by any one of extension numbers “12”˜“15” which were allocated to the extension telephones 103c through 103f. In this case, the extension telephone 103c and the extension telephone 103d belong to both of the call reception groups 1 and 2, and therefore, if they are in a waiting status in which a call can be received, a call from a customer, which was received through the external line “092-111-1111”, or the external line “092-111-1112”, is to be received by the extension telephone 103c or the extension telephone 103d.

Meanwhile, although it is not shown in the figure, a manager terminal is connected to the CCS server 105, and the manager terminal is receiving notification of an extension line status of the extension telephone 103, and of content of the queue 153, from the CCS server 105. Then, display means of the manager terminal carries out such hierarchization that an upper layer was set up as an call reception group and a lower layer was set up to operators who belong to that call reception group, and displays it.

Meanwhile, the storage means 155, which was described above, may be configured by a memory which has a required storage capacity. Furthermore, each of the extension line management means 151, the queue 153, the call log accumulation means 156, and the call reception group setup means 158 may be realized as storage areas secured in the storage means 155.

-Operator Terminal 104-

As shown in FIG. 28, the operator terminal 104 is equipped with call reservation means 141, notification means 142, and display means 143. The call reservation means 141 has a function of requesting a call log to the extension telephone 103 which forms a pair, e.g., to the CCS server 105, and selecting a call from the external line 108 which was wished to be reserved for a talk, out of this call log, and associating this extension telephone 103a as a call reservation destination to use it as talk reserved call information. This is carried out by selecting a calling party telephone number, customer ID and identification ID which are wished to be reversed for a talk, out of a call log which is displayed by GUI (Graphical User Interface) on the display means 143, through the use of input means such as a mouse and a keyboard which is not shown in the figure, and setting up it in “a call reservation window” which was newly displayed.

When an operator sets up a call reservation in “the call reservation window”, the call reservation means 141 forms talk reserved call information by associating a calling party telephone number, customer ID and identification ID, which discriminate a selected call from an external line with a code which discriminates the operator terminal 104a. Meanwhile, it is possible to include information during a period of a talk, in a call log, and therefore, it is possible to make a call reservation as to a call from the external line 108 which is in a talk status. In addition, it is possible to set up expiration date in “the call reservation window”. The call reservation means 141 includes this expiration date in talk reserved call information and transmits it to the CCS server 105. By this means, the call reservation control means 154 of the CCS server 105 deletes such talk reserved call information that setup of expiration date passed over, from the storage means 155, and thereby, it is possible to release a call reservation.

The notification means 142 has a function of transmitting talk reserved call information to the CCS server 105. The display means 143 displays a calling party telephone number, customer ID, identification ID etc., from call reception notification which is notified from the CCS server 105, and informs an operator of a telephone number etc. of a customer from whom a call is received. In addition, it displays a call log which is obtained by the call reservation means 141, “call reservation window” which is displayed on the occasion of a call reservation.

Meanwhile, the operator terminal 104 can be also configured as a call center system in which an extension telephone was omitted, by having a personal computer equipped with a telephone function. In that case, by securing a required storage capacity in a memory which the personal computer has, the call reservation means 141 may be configured. For example, it is possible to realize the call reservation means 141 by selecting a call from the external line 108 which was wished to be reserved for a talk out of a call log of the CCS server 105 and storing such a flag that setup of a call reservation was made, in data of the call log.

Next, an operation of the call center system in the embodiment of the invention will be described on the basis of FIG. 25 through FIG. 32, and FIG. 34 through FIG. 43. FIG. 34 through FIG. 43 show display examples of the operator terminal and the CCS server. Here, the operator terminal 104a is associated with the extension telephone 103a, and an operator 1, who is a user of the operator terminal 104a and the extension telephone 103a, is set to “Johny Dorofty” who belongs to “Sales” which is a sales and marketing department in a call reception group 1.

As shown in FIG. 29, firstly, a call from a customer A reaches to the exchange 102 (S501). The call status notification means 122 of the exchange 102 transmits call reception notification of the call from the customer A, to the CCS server 105 (S502).

When the extension line control means 152 of the CCS server 105 receives the call reception notification from the exchange 102, it searches the extension telephone 103 which is available to receive a call, with reference to an call reception group to the call from the customer A, the extension line 109 which belongs to that call reception group, and a talk status of the extension telephone 103 which is connected to that extension line 109, from content of the call reception group setup means 158 and an extension line status of the extension line management means 151.

Here, the call from the customer A is an incoming call to the call reception group 1, and the extension telephone 103, which is available to receive a call at that time, is assumed to be the extension telephone 103a. The extension line control means 152 notifies an extension number of the extension telephone 103a to the call control means 123 of the exchange 102, in order to have the call from the customer A reached to the extension telephone 103a (S503).

The call control means 123 of the exchange 102, which received notification so as to have the call from the customer A reached to the extension telephone 103a, has the call from the customer A reached to the extension telephone 103a, and sounds the extension telephone 103a. The call status notification means 122 notifies to the CCS server 105 that a call was received by the extension telephone 103a which the operator 1 uses, when it detects that the call from the customer A was received by the extension telephone 103a (S504). Meanwhile, in this call reception notification, a calling party number (Caller ID) and a receiving party number (DID) etc. are included.

The extension line control means 152 of the CCS server 105, which received such notification that a call was received by the extension telephone 103a, from the exchange 102, notifies that notification to the operator terminal 104a which the operator 1 uses. The operator terminal 104a, which received the notification, carries out display etc. of call reception on the display means 143, and thereby, it is possible to visually confirm call reception as well as sounding of the extension telephone 103a. Display examples of the operator terminal 104a and the CCS server 105 at the time that a call from the customer A was received will be shown in FIG. 34. As shown in FIG. 34(a), a status area (Status) shows a period of call reception (Offering), and thereby, it can be judged from a calling party number that a call from the customer A was received by the extension telephone 103a. Further, it can be judged from a receiving party number, which line of the exchange 102 a call reached.

In addition, FIG. 34(b) shows that a call from the customer A reaches to “Johny Dorofty” of the call reception group “Sales” (S505).

Meanwhile, in the display example of FIG. 34(a), only a calling party number is displayed, but, in the CCS server 105, when a calling party name, which corresponds to the calling party number which is sent from the exchange 102, was taken out from the storage means 155, and it was transmitted to the operator terminal 104a together with notification of call reception, the calling party name is also displayed on the operator terminal 104a.

In addition, information regarding extension telephones etc. is all notified from the extension line management means 151 of the CCS server 105, to a manager terminal, and it is possible to display a status of each operator. Here, FIG. 34(a), which shows a display example of the manager terminal, shows that an icon, which shows a call from the customer A to “Johny Dorofty” of the call reception group “Sales”, is displayed.

The operator 1 hooks up (responds) since the extension telephone 103a is sounding because of call reception. The exchange 102 detects off-hook of the extension telephone 103a, and connects a talk channel between a call from the customer A and the extension telephone 103a, and turns the customer A and the operator 1 into a talk status. In addition, the call status notification means 122 of the exchange 102 notifies that the extension telephone 103a responded, to the CCS server 105. By this notification, the extension line management means 151 changes an extension line status of the extension telephone 103a to a talk status (S506).

The extension line management means 151 of the CCS server 105, which received such notification that the extension telephone 103a responded to the call from the customer A, from the exchange 102, transmits such response notification that it responded, to the operator terminal 104a (S507).

The operator terminal 104a, which received the notification, changes call reception display which was displayed on the display means 143, to talk status display. Displays of the operator terminal 104a and the CCS server 105 at the time of talking with the call from the customer A are shown in FIG. 35. As shown in FIG. 35(a), a status area (Status) shows a period of talking (talking), and thereby, it can be judged that a call from the customer A and the extension telephone 103a are in a talk status. In addition, FIG. 35(b), which shows a display example of a manager terminal, shows that it is in a talk status, by making an icon which shows the call from the customer A to “Johny Dorofty” of the call reception group “Sales” different from one shown in FIG. 34(b).

The operator 1, who talked with the customer A by use of the extension telephone 103a, completes the talk, and turns the extension telephone 103a into an on-hook status, and cuts off the call from the customer A. By this cutoff, the call status notification means 122 of the exchange 102 notifies cutoff notification showing that the extension telephone 103a cut off the call from the customer A, to the CSS server 105 (S508).

The extension line management means of the CCS server 105, which received the cutoff notification from the exchange 102, turns an extension line status of the extension telephone 103a into a waiting status due to that cutoff notification, and transmits it to the operator terminal 104a (S509).

The operator terminal 104a, which received the notification, changes the talk status display, which was displayed on the display means 143, to waiting status display. Display examples of the operator terminal 104a and the cCS server 105a at the time that the call from the customer A was cut off are shown in FIG. 36. As shown in FIG. 36(a), there is no display showing the call from the customer A, and thereby, it can be judged that the call from the customer A was cut off and the extension telephone 103a is in a waiting status. In addition, FIG. 36(b), which shows a display example of a manager terminal, shows that the extension telephone 103a is in a waiting status, judging from such fact that there is no display showing the call from the customer a in “Johny Dorofty” of the call reception group “Sales”.

When a display request of a call log is inputted from the operator 1 to the operator terminal 104, the call reservation means 141 of the operator terminal 104a notifies an obtaining request of a call log, to the CCS server 105. Call log information of the call log accumulation means 156 of the CCS server 105 is notified to the operator 104a, by the notification means 157. The display means 143 of the operator terminal 104a displays the call log information which was received from the CCS server 105.

A display example of a call log, which was displayed on the operator terminal 104a, is shown in FIG. 37. The operator 1 selects a talk partner which is desired to be reserved for a talk from the displayed call log. Meanwhile, the selection is carried out by selecting a calling party telephone number, customer ID, identification ID etc. which are desired to be reserved for a talk, out of the call log.

When the selection of a call reserved partner of the operator 1 is detected, the display means 143 displays “a call reservation window”, on the basis of the selected calling party telephone number, customer ID, identification ID etc. A display example of “the call reservation window” is shown in FIG. 38. In FIG. 38, a calling party number and customer ID of the selected partner are displayed in a column of “Customer ID or Caller ID”. In addition, in a column of “Agent Name”, an operator name “Johny Dorofty” of the operator terminal 4a is displayed, and in a column of “Group Name”, the call reception name “Sales”, to which the operator 1 belongs, is displayed.

In addition, a column of “Start Date” is used for setting up reservation starting time, and a column of “End Date” is used for setting up reservation ending time. Here, the columns of “Agent Name” and “Group Name” are used for specifying an operator as a reservation source, and in case of default, information, which corresponds to the operator 1 of the operator terminal 104a, is displayed, but it is possible to change it by an operation from the operator terminal 104a.

For example, by changing the column of “Agent Name” to an operator name of the operator terminal 104b, it is possible to allow a customer of a caller number which is displayed in the column of “Customer ID or Caller ID” to reach to the operator terminal 104b. In addition, a column of “Group Name” is used for selecting which call reception group it is reserved as, in case that an operator belongs to a plurality of call reception groups, and it becomes possible to get hold of which group call processing of an operator was carried out in, from a work report which the CCS server 105 outputs.

After the operator 1 carried out confirmation and a necessary change as to “Agent Name”, “Group Name”, “Start Date”, “End Date” in “the call reservation window” which is displayed on the operator terminal 104a, an OK button, which is GUI-displayed, is depressed, and thereby, information of each column is notified by the call reservation means 141 to the CCS server 105 as reserved call information, and a call reservation is fixed (S510). Meanwhile, it is also possible to dispose a plurality of setups of reservation periods.

Next, a call from a customer A reaches to the exchange 102 (S511). The call status notification means 122 of the exchange 102 transmits call reception notification of the call from the customer A, to the CCS server 105 (S512).

When the extension line control means 152 of the CCS server 105 receives the call reception notification from the exchange 102, it searches the extension telephone 103 which is available to receive a call, with reference to an call reception group to the call from the customer A, the extension line 109 which belongs to that call reception group, and a talk status of the extension telephone 103 which is connected to that extension line 109, from content of the call reception group setup means 158 and an extension line status of the extension line management means 151.

Here, the call from the customer A is an incoming call to the call reception group 1, and the extension telephone 103, which is available to receive a call at that time, is assumed to be the extension telephone 103a. The extension line control means 152 notifies an extension number of the extension telephone 103a to the call control means 123 of the exchange 102, in order to have the call from the customer A reached to the extension telephone 103a (S513).

The call control means 123 of the exchange 102, which received notification so as to have the call from the customer A reached to the extension telephone 103a, has the call from the customer A reached to the extension telephone 103a, and sounds the extension telephone 103a, and notifies to the CCS server 105 that a call was received by the extension telephone 103a which the operator 1 uses (S514).

The extension line control means 152 of the CCS server 105, which received such notification that a call was received by the extension telephone 103a, from the exchange 102, notifies that notification to the operator terminal 104a which the operator 1 uses (S515).

The operator 1 hangs up the extension telephone 103a since it is sounding, and starts a talk with a customer B. The customer B and the operator 1 stars a talk, and thereby, the exchange 102 notifies that it responded, to the CCS server 105. By this notification, the extension line management means 151 turns an extension line status of the extension telephone 103a into a talk status (S516).

The extension line management means 151 of the CCS server 105, which received such notification that the extension telephone 103a responded to the call from the customer B, frm the exchange 2, transmits such response notification that a response was made to the operator terminal 104a (S517).

As above, in such a status that the customer B is talking with the operator 1, a call from a customer C reaches to the exchange 102, as shown in FIG. 30 (S518).

The call status notification means 122 of the exchange 102 transmits the call from the customer C to the CCS server 105 (S519).

Here, the call from the customer C is an incoming call to the call reception group 1, and in the call reception group 1, there is no extension telephone which is available to receive a call at that time (the extension telephone 103a is assumed to be in a talk status). The extension line control means 152 judges that the call from the customer C is an incoming call to the call reception group 1, and in the call reception group 1, there is no extension telephone which is available to receive a call at that time, and notifies a waiting to the exchange 102 so as to turn the call from the customer C into a distribution waiting status, and queuing is applied to a distribution waited call which was set to a distribution waiting where a call is not reserved in the queue 153 and is a call from an external line, as a normal call (S520).

The exchange 102, which received notification of waiting, transmits a message which draws on waiting for a talk (OGM: OutGoing Message) to the customer C as sound. Display examples of the operator terminal 104a and the manager terminal at the time that a talk is going on with the call from the customer B and the call from the customer C became a distribution waited call are shown in FIG. 39. As shown in FIG. 39(a), the call from the customer C is displayed on current queue (Current Queue) as a normal call which is a distribution waited call which is not reserved for a talk. In addition, as shown in FIG. 39(b), the call from the customer C which was stored, is displayed in the call reception group “Sales” of “Queue” which shows content of the queue 153 (S521).

After that, a call of a customer D reaches to the exchange 102 (S522). The call status notification means 122 of the exchange 102 transmits call reception notification of the call from the customer D to the CCS server 105 (S523).

Here, assuming that the call from the customer D is an incoming call to the call reception group 1 and there are no extension telephones 103a˜103d of the call reception group 1 which are available to receive a call at that time, the extension line control means 152 notifies a waiting to the exchange 102 so as to turn the call from the customer D into a distribution waiting status, and applies queuing to the queue 153 as a normal call (S524).

The exchange 102, which received notification of waiting, transmits a message which draws on waiting for a talk (OGM: OutGoing Message) to the customer D. Display examples of the operator terminal 104a and the manager terminal at the time that a talk is going on with the call from the customer B and the call from the customer D became a distribution waited call are shown in FIG. 40. As shown in FIG. 40(a), the call from the customer D is displayed on current queue (Current Queue) together with a normal call of the call from the customer C. As shown in FIG. 40(b), the call from the customer D is displayed in the call reception group “Sales” of “Queue” which shows content of the queue 153, together with the call from the customer C which was stored (S525).

Then, the call from the customer A reaches to the exchange 102 (S526).

The call status notification means of the exchange 102 transmits call reception notification of the call from the customer A to the CCS server 105 (S527).

Here, assuming that the call from the customer A is an incoming call to the call reception group 1 and there are no extension telephones 103a˜103d of the call reception group 1 which are available to receive a call at that time, the extension line control means 152 notifies a waiting to the exchange 102 so as to turn the call from the customer A into a distribution waiting status, and applies queuing to the queue 153 as a normal call which is a distribution waited call reserved for a talk, in order to be matched with a call from a customer which was stored in the storage means 155 as talk reserved call information (S528).

Meanwhile, judgment of whether or not it is matched with a call from a customer which was stored in the storage means 155 as talk reserved call information is carried out by whether or not a caller number, which is included in call reception from the customer A is matched with a caller number which was stored as talk reserved call information in the storage means 155. Here, a distribution waited call, which is queued in the queue 153 by the extension line control means 152, will be described on the basis of FIG. 31 and FIG. 32.

As described above, as to normal distribution waited calls, a the oldest stored distribution waited call is taken out in first from the queue 153. Therefore, by storing distribution waited calls in the order corresponding to call reception, distribution waited calls are taken out in the order corresponding to call reception. As shown in FIG. 31(1), a distribution waited call which is not reserved for a talk is stored as a normal call 1. As shown in FIG. 31(2), when a next distribution waited call is stored, it is stored as a normal call 2 with priority next to the normal call 1.

This shows that the calls from the customer B and the customer C are stored in the queue 153 as distribution waited calls respectively, since there is no extension telephone 103 which is available to receive a call, and the call from the customer B corresponds to the normal call 1, and the call from the customer C corresponds to the normal call 2.

As shown in FIG. 31(3), a reserved call from the customer A was received again, but there is no extension telephone 103 which is available to receive a call, and therefore, it is stored in the queue 153 as a distribution waited call. In this case, since a call reservation is made, it is stored as a reserved call 1 in preference to the normal call 1.

As shown in FIG. 31(4), in the same manner, in case that a distribution waited call, which was reserved for a talk, is stored in the queue 153, it is stored in preference to a normal call. In this case, a distribution waited call, which was stored as a reserved call 2, has higher priority than the normal calls 1 and 2, and has a lower order of call reception than the reserved call 1, and therefore, it becomes priority next to the reserved call 1.

As above, a distribution waited call, which was reserved for a talk, is stored in the queue 153 in preference to a normal call. Therefore, when the extension telephone 103, which is a reservation source of a distribution waited call which was reserved, become available to receive a call, the distribution waited call, which was reserved, is taken out, and received by the extension telephone 103 as a reservation source. However, if there is the extension telephone 103 which is available to receive a call, other than the extension telephone 103 which is a reservation source of a talk reserved distribution waited call, a normal distribution waited call is taken out, and received by the extension telephone 103 which is available to receive a call.

In addition, as shown in FIG. 32, a normal call and a reserved call may be stored as different queues. As shown in FIG. 32(1), the queue 153 has queue for storing a normal call and queue for storing a reserved call. Firstly, the normal call 1, which is a distribution waited call which is not reserved for a talk, is stored in the queue for storing a normal call. As shown in FIG. 32(2), in case that a distribution waited call, which is not reserved for a talk, is stored as the normal call 2, it is stored in the queue for storing a normal call. Since the call reception order of the normal call 1 is older, it becomes next to the normal call 1.

As shown in FIG. 32(3), in case of storing the reserved call 1 which was reserved for a talk, it is stored in the queue for storing a reserved call. As shown in FIG. 32(4), in case of storing the reserved call 2 which was reserved for a talk, it is stored in the queue for storing a reserved call, and since the call reception order of the reserved call 1 is older, it becomes next to the reserved call 1. The extension telephone 3 of a reservation source becomes available to receive a call and in case of taking out from these queues, it is taken out from the queue for storing a reserved call, and thereby, it is possible to heighten priority. Meanwhile, in case that there is no reserved call in the queue for storing a reserved call, it is taken out from the queue for storing a normal call. On one hand, the extension telephone 103 other than the extension telephone 103 of a reservation source becomes available to receive a call, and in case of taking out from these queues, it is taken out from the queue for storing a normal call.

As to the queue 153, in this manner, a normal call and a reserved call may be made as the same queue, and may be made as different queues. In addition, the above-described queue was disposed with respect to each call reception group, but all call reception groups may be made as one queue. By judging whether a distribution waited call is reserved for a talk or not, and which call reception group a distribution waited call is addressed to, in the order corresponding to each distribution waited call with high priority, on the occasion of taking out these distribution waited calls, it is possible to realize control which does not rely on a configuration of a queue. In this manner, the extension line control means 152 controls a call from the customer A as a reserved call in preference to the normal calls 1, 2 which are calls from the customer C and the customer D.

Display examples of the operator terminal 104a and the CCS server 105 at the time that a talk is going on with the call from the customer B and the call from the customer A became a suspended call are shown in FIG. 41. As shown in FIG. 41(a), the call from the customer A is displayed on a top of current queue (Current Queue) as a reserved call which is reserved for a talk, in preference to a normal call which is distribution waited calls from the customer C and the customer D. In addition, since “R” which shows that it is a reserved call, is added, it is possible to easily discriminate it. As shown in FIG. 41(b), in the same manner, a reserved call of the call from the customer A is displayed in a top of the call reception group “Sales” of “Queue” which shows content of the queue 153, in preference to the calls from the customer C, the customer D which were stored.

Going back to FIG. 30, the exchange 102, which received notification of waiting, transmits OGM (Outgoing Message) which shows that it become distribution waiting, to the customer D (S529).

The operator 1, who talked with the customer B by use of the extension telephone 103a, completes the talk and turns the extension telephone 103a into an on-hook status, and cuts off a call from the customer B. By this cutoff, cutoff notification of the call from the customer B is notified to the CCS server 105 (S530).

The CCS server 105, which received the cutoff notification from the exchange 102, turns an extension line status of the extension telephone 103a into a waiting status, due to that cutoff notification, and transmits it to the operator terminal 104a (S531).

The extension line control means 152 of the CCS server 105 notifies to the exchange 102 so as to have the call from the customer A, which corresponds to talk reserved call information of a call which was reserved for a talk, reached to the extension telephone 103, in preference to distribution waited calls of the customer C and the customer D, since the extension telephone 103a, which corresponds to the talk reserved call information, was turned into a waiting status in which a call can be received (S532).

The exchange 102, which received notification so as to have the call from the customer A reached to the extension telephone 103a, has the call from the customer A reached to the extension telephone 103a, and sounds the extension telephone 103a, and notifies that a call was received by the extension telephone 103a which the operator 1 uses, to the CCS server 105. A display example of the operator terminal 104a at the time that the call from the customer A was received is shown in FIG. 42. As shown in FIG. 42(a), since “R” is added to a calling party telephone number of the customer A, it is possible to easily discriminate that it is a talk reserved call. In addition, as shown in FIG. 42(b), in the same manner, a call from the customer A to which “R” was added is displayed in the call reception group “Johny Dorofty” (S533).

The extension line control means 152 of the CCS server 105, which received such notification that a call reached from the exchange 102 to the extension telephone 103a, notifies that notification to the operator terminal 104a which the operator 1 uses, and the notification means 142 notifies that the received call from the customer A is a talk reserved call, to the extension telephone 103a (S534).

In this manner, when a call from an external line, which was associated with talk reserved call information, has reached again to the exchange 2, it is possible to have an extension telephone, which is set up as a call reservation destination, received the call, and therefore, in case that there was a call from the same customer again, it is possible to easily send it to the same operator.

In addition, in case that expiration date of a call reservation was set to be until 5 PM of a next day in S510 of FIG. 29, the extension line control means 152 of the CCS server 105 removes talk reserved call information from the storage means if there is no call from the customer A even when it passed over 5 PM of a next day which is expiration date.

Therefore, in case that it is instructed so as for an operator to make a call again only if a problem relapsed in content of a talk with a customer and there is no occurrence of problems and there occurs no telephone call, and in case that an extension telephone to be used is changed due to rotation of operators, a call reservation is automatically released, and therefore, it is possible to prevent a call from being received erroneously.

In addition, during a period of talking, it is also possible for an operator to make a call reservation to a call thereof A display example is shown in FIG. 43. As shown in FIG. 43(a), by selecting a call which is in a talk status and carrying out a right click etc. of a mouse, the display means 143 detects this, and displays a selection screen. Then, when a call reservation is selected, “a call reservation window” is displayed by the display means 143, as shown in FIG. 43(b). Subsequently, an operator confirms and changes each column of “the call reservation window”, and makes a call reservation. Meanwhile, since an explanation of a call reservation in “the call reservation window” has been already described above, it will be omitted.

Meanwhile, in the embodiment of the invention. the CCS server 105 and the exchange 102 were explained separately, but a function of the CCS server 105 may be taken in (included) in the exchange 102. In addition, the function of the CCS server 105 may be taken in one of the operator terminals 104. In addition, in the embodiment of the invention, the operator terminal 104 and the extension telephone 103 were explained separately, but a function of the extension telephone 103 may be taken in the operator terminal 104.

In addition, a personal computer is used as an operator terminals, and the personal computer is equipped with a telephone function, and thereby, it is also possible to realize a call center system in which an extension telephone was omitted. Meanwhile, also as to a personal computer which was equipped with a telephone function (CTI telephone), similar content is described in open information (2002-0028353 US. Publication No.) as described above, and therefore, explanations will be omitted by quoting an open document.

Furthermore, in the above-described explanation, for the sake of convenience on explanation, the embodiments 1 through 4 and the embodiment 5 were described as different systems. However, the invention is not limited to this content, and all of the embodiments 1 through 5 may be integrated in one system. For example, the storage means 53 and the storage means 155 are integrated to secure required storage capacity, and thereby, it is possible to integrate the extension line management means 51, the call reservation means 56, the call reception group setup means 58, 158 and the call log accumulation means 156, and it is possible to integrate them into one call center system.

The invention was described in detail or with reference to specific embodiments, but it is obvious to a person with ordinary skill in the art that it is possible to add various changes and modifications without departing from a sprit and a scope of the invention.

This application is based on Japanese patent application 2004-066906 filed on Mar. 10, 2004 and Japanese patent application 2004-130993 filed on Apr. 27, 2004, and its content is taken in there for reference.

A call center system, which relates to the invention, makes a call reservation for a call from a customer which became distribution waiting in case that there is no extension telephone which is available to receive a call, and can select an extension telephone which is allowed to receive a call.

In addition, a call center server, an operator terminal and a computer program, which relate to the invention, has a function of having a call from an external line, which was associated with talk reserved call information, reached to an extension telephone which was set up as a call reservation destination, when the call reaches to an exchange again, and therefore, it is useful as a call center system which carries out call reception allocation of calls from an external line to a plurality of operators.

1. A call center system, which is connected to an exchange which forms a talk channel between an external line and a plurality of extension telephones and which allows a call from the external line to be received by the extension telephone, comprising:
selection means which selects a call from one or more external lines, which is in a reception waiting status to extension telephones, and selects a call reception destination of the selected call from the external line, and sets up it as a call reservation destination,
call reservation means which associates the selected call from the external line with an extension telephone as the call reservation destination, and stores them as talk reserved call information, in storage means, and
call reception notification means which transmits, on the occasion that the extension telephone, which was associated with the talk reserved call information, became available to be received, such notification that the selected call from the external line is allowed to be received by this extension telephone, to the exchange.

2. The call center system as set forth in claim 1, further comprising:
notification means which selects a call from one or more external lines which is call reception waiting to extension telephones, and selects call reception destinations of the selected calls from the plurality of extension telephones, so that a plurality of operator terminals as call reservation destinations are connected thereto, and notifies a call from one or more external lines which is call reception waiting to extension telephones, to the plurality of operator terminals, and
call reservation reception means which notifies a call reservation destination which was selected by the operator terminal, to the call reservation means.

3. The call center system as set forth in claim 2, further comprising:
talk reserved call control means which measures elapsed time from such time that the talk reserved call information was stored in the storage means, and, in case that the measured elapsed time becomes predetermined time or more and the call from the external line can not be received by the extension telephone of the call reservation destination, notifies warning notification to the operator terminal which selected the extension telephone of the call reservation destination.

4. The call center system as set forth in claim 3, the talk reserved call control means has a function of notifying to the connection notification means so as to have a call reached to another extension telephone which is available to receive a call, in case that the talk reserved call control means measures elapsed time after the warning notification was notified, and the measured elapsed time becomes predetermined time or more, and a call from the external line can not reach to the extension telephone of the call reservation destination.

5. An operator terminal which is connected to a call center system comprising an exchange which forms a talk channel between an external line and the plurality of extension telephones and allows a call from the external line to be received by the extension telephone, call reservation means which makes a connection of the selected call from the external line with an extension telephone as the call reservation destination, and stores them as talk reserved call information, in storage means, and connection notification means which transmits, on the occasion that the extension telephone, which was associated with the talk reserved call information, became available to be received, such notification that the selected call from the external line is allowed to be received by this extension telephone, to the exchange, and which are installed as pairs with respective extension telephones, the operator terminal comprising:
reception means which receives information of a call from one or more external lines which is call reception waiting to extension telephones from the call center system,
selection means which selects a call from one or more external lines which is call reception waiting to extension telephones, and selects call reception destinations of the selected calls from an external line from the plurality of extension telephones to set up it as a call reservation destination, and
call reservation notification means which associates information of the selected call from an external line with extension telephone of the call reservation destination, and notifies it to the call center system as talk reserved call information.

6. A computer program characterized by having
a computer which is connected to an exchange which forms a talk channel between an external line and a plurality of extension telephones and which allows a call from the external line to be received by the extension telephone, and an extension terminal which is installed as a pair with each of extension telephones, functioned as
selection means which selects a call from one or more external lines, which is in a reception waiting status to extension telephones, and selects a call reception destination of the selected call from the external line, and sets up it as a call reservation destination,
call reservation means which associates the selected call from the external line with an extension telephone as the call reservation destination, and stores them as talk reserved call information, in storage means, and
connection notification means which transmits, on the occasion that the extension telephone, which was associated with the talk reserved call information, became available to receive a call, such notification that the selected call from the external line is allowed to be received by this extension telephone, to the exchange.

7. A call reservation method, which forms a talk channel between an external line and a plurality of extension telephones and which allows a call from the external line to be received by the extension telephone, comprising:
a step of selecting a call from one or more external lines, which is in a reception waiting status to extension telephones,
a step of selecting the selected call from an external line from the plurality of extension telephones to set up it as a call reservation destination,
a step of associating the selected call from an external line with an extension telephone of the call reservation destination and storing it as talk reserved call information, and
a step of having, on the occasion that the extension telephone, which was associated with the talk reserved call information, became available to receive a call, the selected call from an external line reached to this extension telephone.

8. A call center system, which is connected to operator terminals which are installed as pairs with a plurality of extension telephones respectively, and an exchange which forms a talk channel between an external line and a plurality of extension telephones and which allows a call from the external line to be received by the extension telephone, comprising:
call reservation control means which stores, as a call reservation destination, talk reserved call information associated with an extension telephone selected to a call from the external line, by an operator terminal which becomes a pair with an extension telephone by which a call from the external line was received, in storage means, and
call reception request means which notifies to an exchange so as to allow an extension telephone which was associated as the call reservation destination to receive a call, when a call from the external line, which was associated with the talk reserved call information, is incoming to the exchange.

9. The call center system as set forth in claim 8, wherein the call reservation control means has a function of removing the talk reserved call information from the storage means, in case that there is no incoming call from an external line associated with the talk reserved call information, and elapsed time from the time that the talk reserved call information was stored in the storage means becomes predetermined time or more.

10. The call center system as set forth in claim 8 or 9, further comprising: distribution waited call management means which manages a call from an external line, which can not be received by the extension telephone, as a distribution waited call, and notifies to the call reception request means so as to receive the distribution waited, calls in the order corresponding to call reception, every time the extension telephone became available to receive a call, and classifies a call from an external line as a distribution waited call in case that the call from the external line can not be received by the extension telephone associated with the talk reserved call information, and allows this distribution waited call to be received, in preference to other distribution waited calls, in case that the extension telephone, which was associated by the talk reserved call information, became available to receive a call.

11. The call center system as set forth in any one of claim 8 through claim 10, further comprising: notification means which informs an operator terminal, which becomes a pair with an extension telephone which is the call reservation destinations of reception of a call from an external line associated with the talk reserved call information, when the call from the external lien associated with the talk reserved call information reaches to an extension telephone which is the call reservation destination.

12. An operator terminal of a call center system, which is connected to a call center system, comprising:
an exchange which forms a talk channel between an external line and the plurality of extension telephones and allows a call from the external line to be received by the extension telephone, call reservation means which makes a connection of the selected call from the external line with an extension telephone as the call reservation destination, and stores them as talk reserved call information, in storage means, and
call reception request means which notifies to an exchange so as to allow an extension telephone which was associated as the call reservation destination to receive a call, when a call from the external line, which was associated with the talk reserved call information, is incoming to the exchange,
call reservation means which associates the selected call from the external line with an extension telephone by which the call from the external line was received and sets it up as talk reserved call information, and
notification means which transmits the talk reserved call information to the call center system.

13. The operator terminal of the call center system as set forth in claim 12, further comprising:
reception means which receives such call reception notification a call from an external line associated with the talk reserved call information was received from the call center server, and
display means which displays the call reception notification.

14. A computer program having
a computer which is connected to operator terminals which are installed as pairs with a plurality of extension telephones respectively, and an exchange which forms a talk channel between an external line and a plurality of extension telephones and which allows a call from the external line to be received by the extension telephone, functioned as
call reservation means which stores talk reserved call information which was associated with an extension telephone selected to the call from the external line, as a call reservation destination, by an operator terminal which is paired with an extension telephone by which a call from an external line was received, in storage means, and
call reception request means which notifies to an exchange so as to allow an extension telephone which was associated as the call reservation destination to receive a call, when a call from the external line, which was associated with the talk reserved call information, is incoming to the exchange.
